(19) United States
(12) Patent Application Publication
(10) Pub. No.: US 2013/0311266 A1
(43) Pub. Date: Nov. 21, 2013

(54) METHOD AND SYSTEM TO PERSONALIZE REWARDS AND LOYALTY PROGRAMS

(71) Applicants: Michael Vichich, Brighton, MI (US); Tyler Felous, New York, NY (US)

(72) Inventors: Michael Vichich, Brighton, MI (US); Tyler Felous, New York, NY (US)

(21) Appl. No.: 13/474,847

(22) Filed: May 18, 2012

(51) Int. Cl. G06Q 30/02

(52) U.S. Cl. 705/14.27

(57) ABSTRACT

A computer system and method that determines personalized transaction yields for one or more payment vehicles in real-time-and can automatically process the transaction on the optimally advantageous vehicle. Embodiments of the invention disclose a system and method that can advise and instantly generate rewards bids for credit issuers and arbitrate, present, and reconcile those rewards bids for consumers.

### FIELD OF THE INVENTION

This invention relates generally to the field of customer loyalty and rewards points, such as loyalty programs typically seen in the retail industry and rewards programs typically seen in the credit card industry. More particularly, it relates to methods and systems used by consumers and reward issuing institutions to create, distribute, personalize, share, and process transaction reward yields for a series of potential transaction vehicles for a given transaction, such as debit card and credit card choices or any other vehicle for financial transactions or other types of transactions.

### BACKGROUND OF THE INVENTION

During calendar year 2009, US consumers executed over 65B debit, credit, and prepaid card transactions totaling $3.48 trillion dollars, according to the 2010 Federal Reserve Payments Study. Moreover, the average consumer has roughly 3.5 credit cards in their wallet, according to a separate study released in 2010 by the Federal Reserve Bank of Boston. At the point of transaction, assuming the merchant accepts all of the major card networks, the consumer has the choice of any transaction vehicle, defined herein as payment types including credit cards, debit cards, ACH transfers, mobile or e-checks, or alternative currencies, to name a few. Oftentimes consumers have one primary card account and use others in rare circumstances, such as when their primary card has been declined, their primary card is not accepted, they have lost their primary card, or their primary card has been stolen. Once the consumer chooses which card to use on each transaction, the card is usually swiped and electronically processed. Once the merchant has received an approval notice, the consumer typically signs for the transaction or enters a PIN, and then departs with their purchased goods or services. Throughout the day the merchant's point of sale system (PoS) stores, or-batches, all of the transactions that were accumulated. At the end of each day, the PoS transmits all of the day's transactions to the payment card networks via the merchant's chosen payments processor, initiating a process called transaction settlement. After a short period of time, usually 24-72 hours, credit issuers settle with merchants by transmitting funds into the merchant's bank account. Funds paid to the merchant are net of transaction fees, known as interchange fees. In the case of online transactions, merchants transmit their transactions through a transaction gateway to their processor. The gateway is an online version of the PoS system.

To motivate consumer spending on a specific transaction vehicle, credit issuers have long used rewards programs as a way to attract targeted customers, offering four main types of rewards: hotel points, air miles; rewards points, and cash back. Although websites exist to provide generalized counsel on reward programs for consumers, such as mint.com or NerdWallet.com, there is no way for consumers to determine in real-time the transaction yield, defined herein as the value of benefits that accrue to consumers by conducting a transaction, of various transaction vehicles. Consequently, consumers often are unaware of the transaction yield until they receive a monthly statement from their credit issuer. Moreover, even in the monthly bill, credit issuers-remain opaque about the exact transaction yield from each transaction, in favor of displaying the total amount of transaction yield accrued over the course of the monthly bill cycle. It is in the credit card companies' collective interest to maintain this opacity, chiefly because increased transparency could cause consumers to become savvier in applying their cards to individual purchases, which, in turn, could increase rewards-related liabilities for the credit card companies.

A myriad of issues exist when delving deeper into how yield is calculated. Today, credit card companies compute a transaction yield from four key elements. The first is the merchant's category, typically denoted by industry identifying information such as a merchant category code or MCC. A merchant's MCC is defined by the merchant's agreement with their payments processor in accordance with the merchant's Standard Industrial Classification (SIC) or North American Industry Classification System (NAICS) code. The second element is a set of reward receipt and redemption criteria of various credit and debit card rewards programs, such as cash back percentages-points or miles redemption schedules, applicable dates of benefits, applicable categories of purchase, and spending limits, to name a few. Third is the total purchase value of the transaction in question, by which cash back or reward point percentages are multiplied to compute the total reward. The fourth element is the value that rewards points carry, for example the value of one hotel point or air mile. Based on the variation in these four variables, transaction yield can fluctuate significantly depending on-factors that change with every transaction.

Yet, credit card rewards programs are static in two key facets related to consumers: their loyalty and preferences. First, transaction yields are predominately the same across all consumer accounts within a given card type (e.g., Chase Freedom), regardless of how loyal-a consumer is to the credit card issuer or merchant. Consumers are usually given the same flat rewards rate, regardless of the percent of their total spend they put on each card. Said differently, consumers who rarely use a card are not given a different transaction yield than consumers who always use a particular card. Thus, rewards programs fundamentally miss their intended goal of motivating consumer loyalty. Second, a consumer's preferences are not taken into account. Take the example of two demographically similar consumers; one may enjoy traveling and therefore prefer travel rewards, such as air miles and hotel points, whereas the other consumer may not enjoy traveling and thus would be more interested in cash-back rewards. In today's world, there is no way for either consumer to quantify the magnitude of their preferences; as a consequence consumers often choose cards based on their overall transaction yields, absent the fact that they may prefer a more nuanced rewards portfolio.

Additionally, consumers have no means to set goals for themselves, which can be achieved through the accrual of rewards points. For example, it would be nice if a family of four planning a vacation to Disney World could simply make that goal known, and then have its rewards preferences adjust accordingly, increasing the value of air miles and hotel points.

Accordingly, there is need for a more efficient and holistic system and method, the results of which enable consumers to more easily and readily identify which card they should use for each transaction and enable issuers to provide a more loyalty-driven, personalized processing platform for administering rewards.

### SUMMARY

The above issues associated with inefficient and non-personal transaction yields are reduced or eliminated by the present invention that determines personalized transaction yields for one or more payment vehicles in real-time-and can automatically process the transaction on the optimally advantageous vehicle. Further embodiments of the invention describe a system and method that can advise and instantly generate rewards bids for credit issuers and arbitrate, present, and reconcile those rewards bids for consumers.

Methods and systems for real-time rewards personalization for one or more of transaction vehicles are described herein. Additionally, a computer system, containing hardware and software, to optimally ascertain transaction yield and to advise and distribute real-time bids for transaction vehicles are-described herein.

Further areas of applicability of the present invention will become apparent from the detailed description provided hereinafter. It should be understood that the detailed description and specific examples, while indicating a commonly accepted embodiment of the invention, are intended for illustrative purposes only and do not limit the scope of the invention to these examples.

### BRIEF DESCRIPTION OF THE DRAWINGS

For a better understanding of the aforementioned embodiments of the invention as well as additional embodiments thereof, reference should be made to the Description of Embodiments below, in conjunction with the following drawings in which like reference numerals refer to the corresponding parts throughout the figures.

FIG. 1 is a flow diagram illustrating a first embodiment of the invention involving a static method by which personalized transaction yield is determined by the system for one or more transaction vehicles.

FIG. 2 is a flow diagram that describes the static embodiment for computing the personalized transaction yield value of a particular transaction vehicle, as associated with the static method in FIG. 1.

FIG. 3 is a flow diagram illustrating an example of the static method and system that produces a recommendation to the user.

FIG. 4 is a flow diagram illustrating the dynamic method by which personalized transaction yield is calculated for one or more transaction vehicles.

FIG. 5 is a flow diagram that describes the preferred embodiment of computing the personalized transaction yield of a particular transaction vehicle.

FIG. 6 is a flow diagram illustrating an example of the dynamic method and system producing a recommendation to the user.

FIG. 7 is an architectural diagram of an embodiment of the system depicting the hardware that constructs the Rewards Personalization Engine and related components of the present invention, including the Transaction Vehicle Personalization Storage Unit (TVPSU) as set forth in FIG. 8.

FIG. 8 is an architectural diagram illustrating the Transaction Vehicle Personalization-Storage Unit (TVPSU) within the Rewards Personalization Engine, which processes the transaction yield of one or more transaction vehicles in real time and in arrears.

FIG. 9 is a view of an interface used to capture the preferences of an individual consumer.

FIG. 10 is a graphical view of a PDA interface for displaying the personalized transaction yield for a series of transaction vehicles according to embodiments of the present invention.

FIG. 11 is another embodiment of a hardware architectural diagram for the static method by which rewards issuers can conceive and create dynamic rewards or loyalty programs in real-time.

FIG. 12 is another embodiment of an architectural diagram depicting the hardware that constructs the Reward Bid Manager and related components of the present invention.

FIG. 13 is a flow diagram for the static and dynamic system that enables a reward-issuing institution to solicit advice for and input real-time rewards bids into the Rewards Bid Storage Unit.

FIG. 14 is a flow diagram illustrating an embodiment of the static and dynamic method and system that enable a reward-issuing institution to solicit advice for and input change requests to previously submitted rewards bids.

FIG. 15 is a flow diagram that illustrates the static embodiment for computing the Personalized Purchase. Likelihood for a consumer of customized characteristics under customized conditions.

FIG. 16 is a flow diagram that illustrates the static embodiment for computing a new or existing Rewards Bid Recommendation that can be displayed to an issuer upon solicitation.

FIG. 17 is a flow diagram illustrating an embodiment of the static method for producing a recommendation to the user by displaying personalized real-time reward bids associated with one or more reward-issuing institutions.

FIG. 18 is a flow diagram that describes the static embodiment for reconciling the reward points recorded by the system and distributed by a reward-issuing institution.

FIG. 19 is a flow diagram that describes the dynamic embodiment for computing the Personalized Purchase Likelihood for a consumer of customized characteristics under customized conditions.

FIG. 20 is a flow diagram that describes the dynamic embodiment for computing a new or existing reward bid recommendation that can be displayed to an issuer upon solicitation.

FIG. 21 is a flow diagram illustrating an example of the dynamic method for producing a recommendation to the user by displaying personalized real-time reward bids associated with one or more reward-issuing institutions; and

FIG. 22 is a flow diagram that describes the dynamic embodiment for reconciling the reward points recorded by the system and distributed by a reward-issuing institution.

### DESCRIPTION OF EMBODIMENTS

### A. Vehicle Yield Personalization During Static Transactions

The present invention provides for a method and system for determining and processing the personalized transaction yield of one or more transaction vehicles. For the purposes of the present invention, transaction vehicles comprise debit or credit card accounts, including but not limited to accounts issued by-international, national, regional, or local credit issuers, ACH transfers, mobile cash transfers, alternative currencies, or any other form of transaction, excluding physical cash or checks.

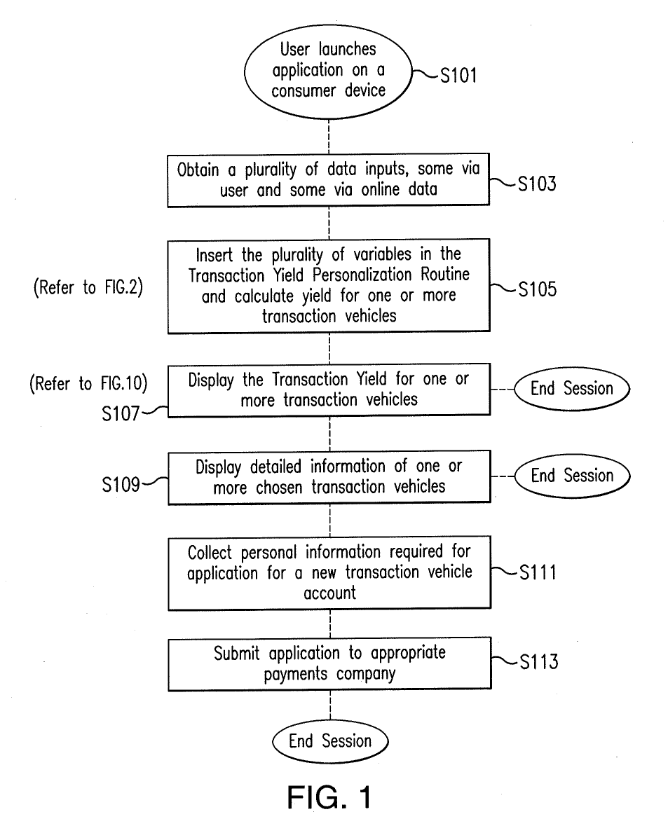

FIG. 1 is a flow diagram that illustrates in a first embodiment the process for determining a personalized transaction yield of one or more transaction vehicles in real-time. Step 101 (S101) of FIG. 1 is triggered when a user has decided to evaluate which transaction vehicle would yield the greatest reward. To execute S101, the user must launch computer executable code, accessed-from a cloud storage infrastructure or from some other form of remote or local computer storage accessible by that user's device. Examples include access to a mobile application or mobile website, on a consumer PDA or tablet computer.

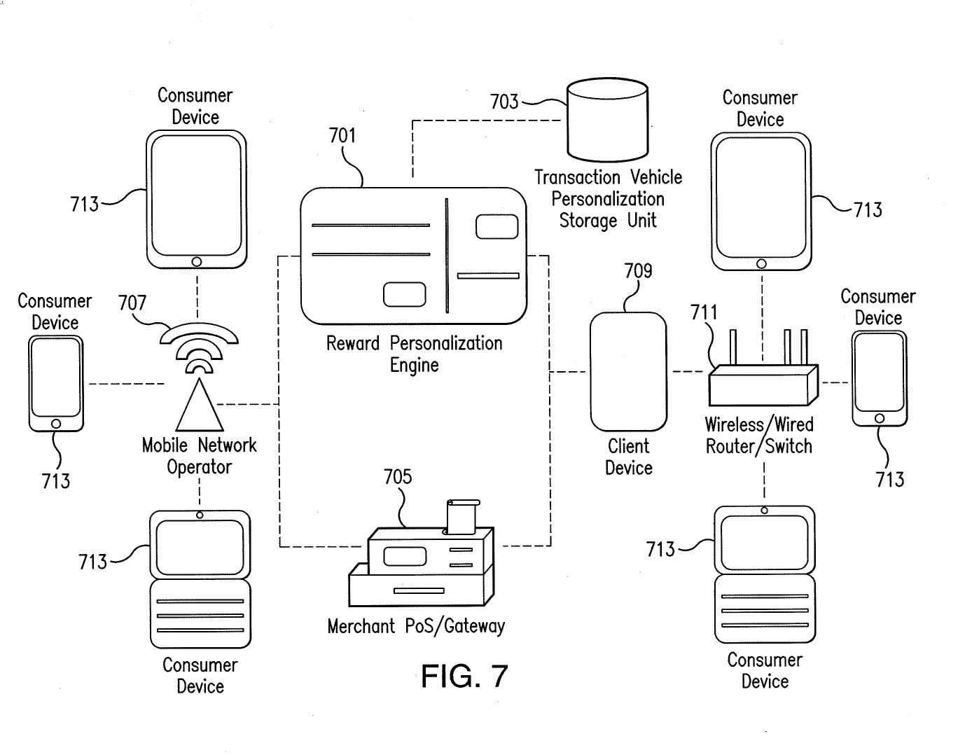

Subsequently, in step S103, several critical variables required to determine a personalized transaction yield are obtained-from various data sources. Some of these data are provided or verified by the user, whereas others are provided and verified by computer executable code and online memories. Included in the plurality of variables used to calculate transaction yield are: 1) transaction amount, 2) transaction vehicle offering information, such as rewards program terms and conditions and which cards are possessed by the user, 3) the merchant's industry identifying information, 4) the transaction date, 5) cash equivalent point values of the various transaction vehicles, for example the cash value of one American Express point or Starwood Preferred Guest point, and—6) the consumer's own preferences for rewards. The consumer's preferences are relevant to the present invention in order to ascertain the relative values placed on different rewards categories. As an example, take one consumer who was an avid traveler and another who did not like to travel. In this example, it is intuitive that travel rewards would be worth more to the consumer who is an avid traveler than the other consumer. The present invention analyzes and processes what is effectively an exchange rate on different rewards currencies, based on each consumer's preferences. As further described herein, these preferences are inputted via the user's device and stored in the system as more fully described in connection with FIG. 7. The system 700 as shown in part in FIG. 7 accesses these preferences in real-time to compute the personalized transaction yield. Without the critical element of personalization, the present invention loses a material amount of value for consumers.

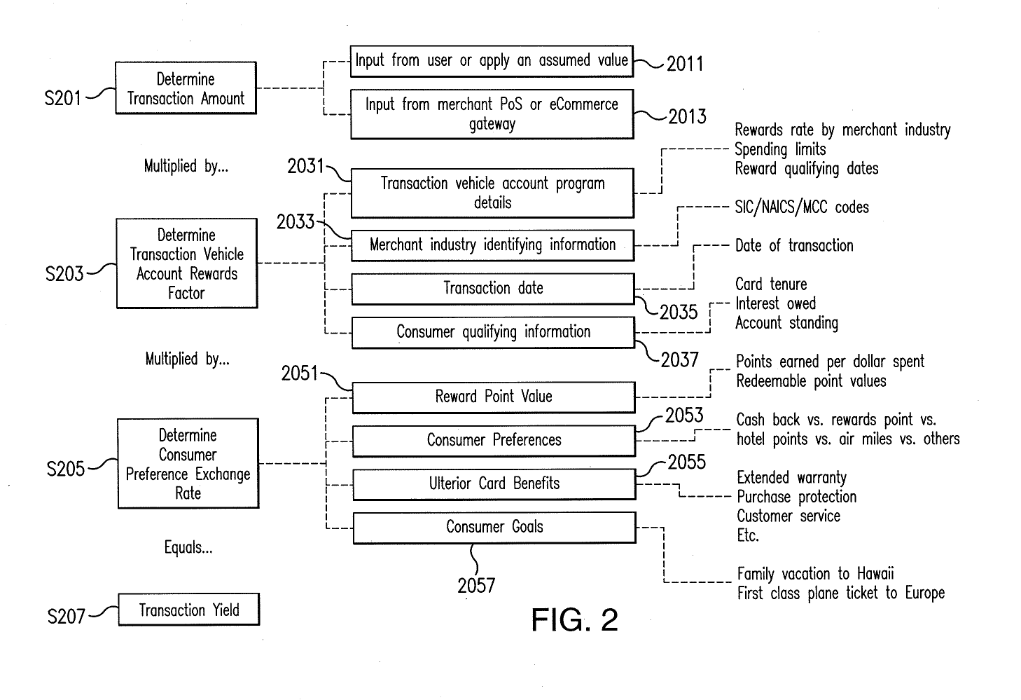

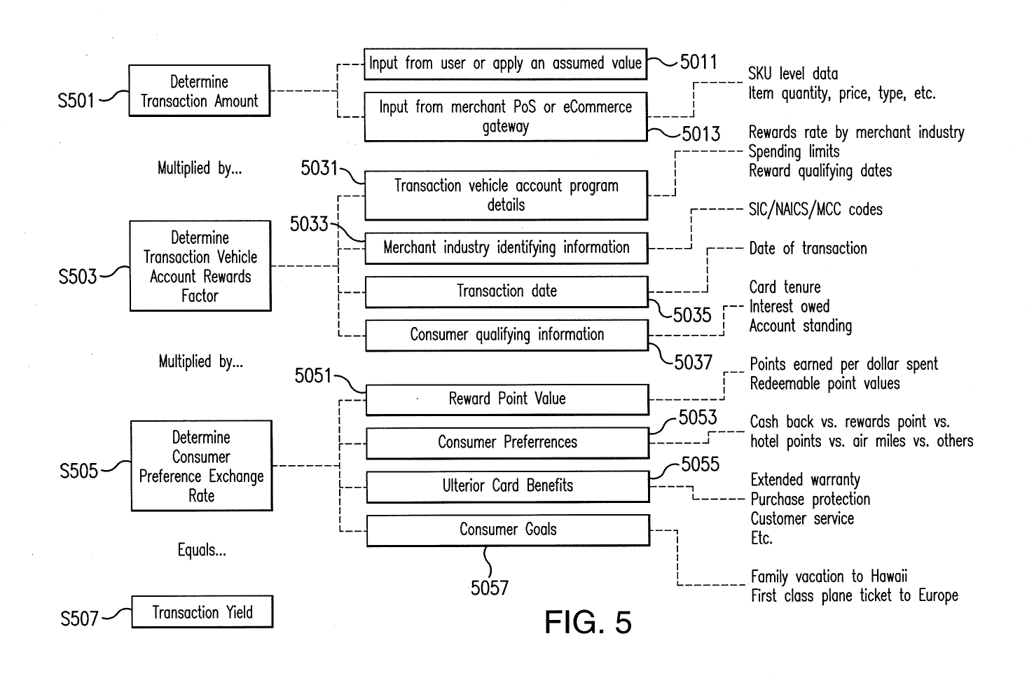

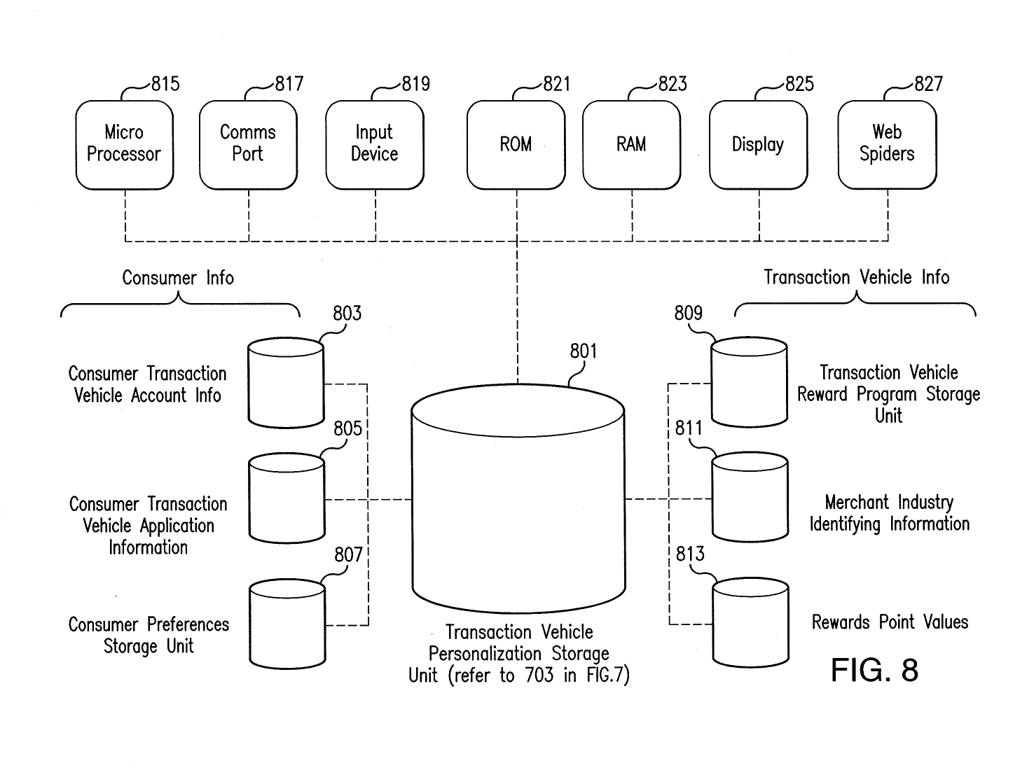

Additionally, information regarding the ulterior benefits of a transaction vehicle, such as excellent customer service, extended warranties, airport lounge access or merchant dispute support is captured by the present invention. These data are included in the Transaction Vehicle Personalization routine, subsequently described in FIG. 2, and included in the transaction yield determination. The yield determination process is also described in greater detail in FIG. 2 and FIG. 5. The preferred embodiment of the present invention includes the collection of the afore-described variables by automated processes that are well known in the art, such as web spiders, or via another means. The web spider's purpose is to methodically evaluate a plurality of web pages that contain data used for calculating the transaction yield. These spiders are provided with a list of URLs to search, initially provided via manual creation; one example of search targets are websites of credit card companies that display each card's rewards program. After being given the list of URLs, the spider will search through the URLs, capture data, and identify more URLs to be subsequently searched. Once data is captured related to any input of the Rewards Personalization routine, it is stored in the Transaction Vehicle Personalization Storage Unit 703 (TVPSU), which is described in greater detail in FIG. 8. Information collected by the spiders could be updated constantly or could be updated on a periodic basis, for example every day or week. While Web spiders are the preferred embodiment to achieve step S103 as described herein, other forms of automated data collection can be deployed by the present invention.

In Step S105, the plurality of variables is inserted into the system 700 to ascertain personalized transaction yield for n transaction vehicles, including those that the consumer currently possesses and those that the consumer does not currently possess. The number of transaction vehicles analyzed, n, can be limited to the customer's own portfolio or it can be expanded to include all of the transaction vehicles offered by every credit issuer available to the user. The processing can be performed locally on the consumer's own device, on remote computing devices or servers, or on the merchant's PoS system. Flow then proceeds to step S107.

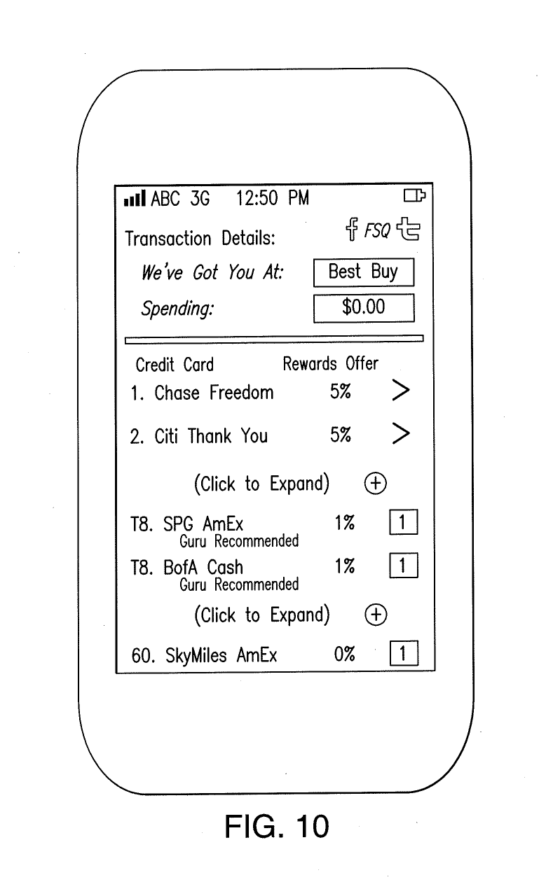

In step S107, the present invention displays the results from step 106. A specific example of this display, as seen by the user, is included in FIG. 10. At this point, the user may decide to close the application on their device and present the recommended form of payment to complete his/her transaction, or-may choose to explore the terms and conditions of a transaction vehicle as set forth in step S109.

If the user has decided to explore one or more transaction vehicles by selecting one of the transaction vehicles displayed in step 107, then step S109 begins. An example would be the user selecting “Bank of America Cash”, as indicated in FIG. 10. When the consumer has selected a transaction vehicle, the present invention displays an overview of the chosen transaction vehicle to the consumer. The present invention will display terms of the transaction vehicle, such as the type of rewards offered, specific rewards categories and yield rates, for example 6% cash back on supermarkets, APR schedules for a person with a like credit score, international use stipulations, applicable annual fees, late fees, whether it offers dynamically created rewards, and age restrictions, among others. The present invention allows transaction vehicle information to be presented without comparison to other card accounts, or it can present the information of two or more card accounts for comparison by the consumer. This information is intended to help the user determine if the transaction vehicle would be advantageous for them to acquire. Step S109 concludes when the user ends their session, returns to the prior screen, or advances to step S111.

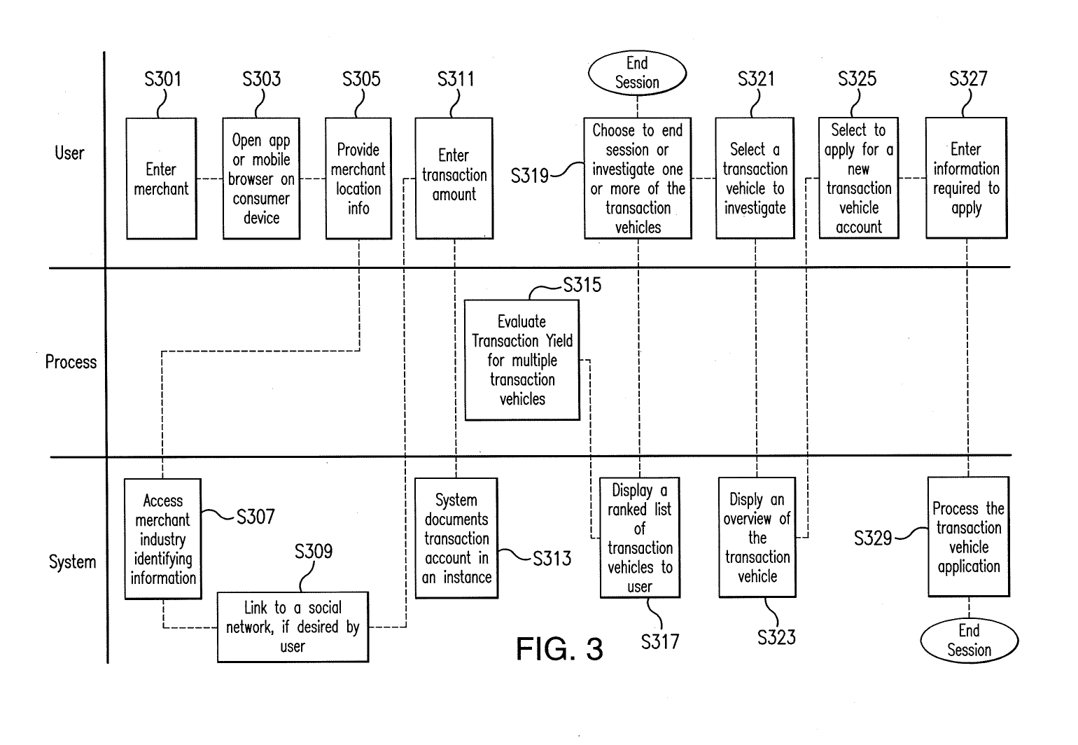

S111 begins when the user, after viewing the specified characteristics of a transaction vehicle, decides to apply for said transaction vehicle. When the user reaches step S111 for the first time, they will be asked to enter a series of personal information required to apply for the credit account, including but not limited to Name, Address, Date of Birth, Email, Phone Number, Annual Income, Occupation, Employer, Time at Job, Social Security Number, and other security information. Once this information has been entered, the user will end step S111 by confirming correct entry of information and applying for the transaction vehicle. The confirming and applying step, for example, can be accomplished by actuating a dedicated screen button on the user's device display. The present invention has the option to store the captured data to accelerate the application process for future transaction vehicles-if given permission by the consumer. Following the first time this information is entered, every subsequent card application event will prompt the user to input a Card Application Personal Identification Number (PIN), as described in FIG. 3.

Step S113 is triggered when the user chooses to confirm and apply for the transaction vehicle. In Step S111, the present invention will automatically distribute the user's application to the appropriate payments company on behalf of the user. The application is submitted electronically by the central system, 700 referred to in FIG. 7.

The method described above illustrates one example of how the user can identify transaction vehicles with economically advantageous rewards programs and ulterior benefits. In FIG. 1, the consumer uses the present invention to identify which transaction vehicle would create the greatest transaction yield, and then the consumer processes the payment, for example, by swiping the recommended card at the merchant's PoS or gateway.

The present invention outlined herein has the ability to calculate transaction yield in real-time or in arrears. The output from the arrears model creates a display that shows the user the aggregate transaction yield forgone over a period of time by not using certain transaction vehicles. This view, as seen by the user, would allow the user to view the top-ranked personalized transaction yield across multiple transaction vehicles for each transaction over the period provided by the user. The user could then click into any individual transaction to see a per-transaction display, the same as shown in FIG. 10. The arrears model follows the same steps outlined above to calculate the personalized transaction yield of each transaction during the specified period. A personal finance program, such as mint.com, QuickBooks, or other personal finance software programs, can provide the historical transaction data. These data can also be aggregated from the individual transactions executed throughout the course of a defined period of time as provided with permission by a user's financial institution. The present invention determines the personalized transaction yield derived vs. the potential yield with a more advantageous blend of transaction vehicles. Ultimately, the purpose of the real-time and arrears embodiments is to inform the consumer about how to select the best transaction vehicle for their own personal preferences, informing the mix of transaction vehicles used.

FIG. 2 illustrates the Transaction Yield Personalization (TYP) routine; by which a personalized transaction yield is processed for a given transaction vehicle and transaction. This data is similar to that data described in FIG. 5, representing the dynamic rewards personalization approach. There are three main components to the TYP: 1) Determination of a Transaction Amount (S201), 2) Determination of a Transaction Vehicle Rewards Account Factor (S203), and 3) Determination of a Consumer Preference Exchange Rate (S205). The order in which the components are determined does not matter and can be easily interchanged. Those reasonably skilled in the art could find alternative means and data sources to execute the same functionality.

The first component, determination of the Transaction Amount can be input from multiple sources, as indicated in FIG. 2. The Transaction Amount is the monetary value of a transaction or potential transaction. Specifically the Transaction Amount would be the total bill one would need to pay at a merchant to complete a transaction. The data to determine the transaction amount can be obtained from two primary sources: 1) input by the user or 2) input via a merchant PoS system or gateway at the point of purchase. Also, as noted in FIG. 2, the present invention has the ability to assume a standard transaction value, so as to reduce the user interaction burden required to key in a transaction value. In the event that the merchant's PoS communicates with the consumer device to automatically populate the transaction value, a secure connection is established over the Internet using, for example, a Secure Socket Layer (SSL) encryption key. It is understood, however, that any form of secure connection can be deployed with this invention. In the present example, as the clerk at the merchant rings up individual items/SKUs, the present invention captures that data and presents it to the consumer in real-time, so the user can see the receipt building dynamically in addition to pricing of individual items. Inputs to this step are none, and the output is an exact transaction value as indicated by the merchant's PoS or gateway system. Once these data have been collected, the Transaction Yield Personalization Algorithm can capture the other two components, as explained below. As previously stated, the order in which these components are discussed does not necessarily mean they must be performed in that order during real-life situations. Given that the method calls for the multiplication of the three components together, they are interchangeable and thus no order can be inferred from this detailed description.

The second component in the Transaction Yield Personalization routine, Determination of a Transaction Vehicle Account Rewards Factor, is referenced in FIG. 2, step S203. Determination of the Rewards Factor requires the retrieval of three types of data that can change in real-time from one or more data stores. The three data inputs are: 1) Transaction Vehicle Account Reward Program Details (S2031), 2) Merchant Industry Identifying Information (S2033), and 3) Transaction Date (S2035), (4) Consumer Qualifying Information (S2037).

The first data input to compute the Account Rewards Factor, Transaction Vehicle Account Reward Program Details, 2031, has several variables contained within it, specifically rewards rates by merchant industry category, rewards eligibility dates, and spending limits enacted by category by the credit issuer. It is understood that more possibilities for account program details exist today than those listed, and further data points can be added as transaction vehicle issuers evolve the way their rewards programs are structured to include features or stipulations not available as of the date of this invention.

The link between Reward Program Details and Merchant Industry Identifying Information, 2033, can be illustrated by an example of credit cards already on the market. Chase Freedom and Discover More, both cash-back cards, have rotating categories for which consumers are entitled to higher levels of rewards, for example 5% cash back, over the normal level of rewards, (e.g. 1% cash back). In order to ascertain whether the consumer is due 5% or 1% cash back for a specific transaction in this example, one must know the rewards programs offered by card issuers, including rewards rates by merchant industry category, and any applicable dates or spending limits. Data for the rewards categories are presented on each credit issuer's website and can change at any moment. Therefore, the present invention calls for the creation of a Transaction Vehicle Information and Rewards Storage Unit (as illustrated in 809 of FIG. 8) that contains this information for all known transaction vehicle options. Data is collected and curated in the present invention by either web spiders or other automated means. The present invention accesses issuers' websites on a periodic basis and can automatically update the stored transaction vehicle information and rewards information to include any new transaction vehicles offered or alterations to existing rewards programs.

Since some credit card reward categories change every few months, one must ascertain the categorization of each merchant on each credit network (Discover, American Express, Visa, and MasterCard) to determine the rewards rate to apply to a specific transaction. Each merchant, when signed up to process card payments by their acquirer, receives a Merchant Category Code (MCC), which indicates to the payment card network companies the type of business in which the merchant is engaged. A merchant's MCC is often the first four digits of the merchant's government registered SIC code, though in certain instances it may be different. The US Census Bureau provides a direct mapping of SIC codes to NAICS codes. As such, the present invention uses any combination of SIC, NAICS, or MCC codes to create what is called the Merchant Industry Identifying Information, 2033 in FIG. 2. When matched with the rewards program details, 2031, this information provides two of the three required variables to determine the transaction yield of a single transaction.

The present invention obtains Merchant Industry Identifying Information data 2033 from multiple potential sources, some publicly available, some privately available for purchase. These data will be stored by the present invention in a dynamic online storage area contained within the Transaction Vehicle Personalization-Storage Unit (TVPD) 703 described in FIG. 8.

The third data input required to ascertain the Account Rewards Factor for a transaction vehicle is the date of the transaction, 2035, which is accessed by the present invention from the consumer's device, the merchant's PoS or gateway system, or some other system or storage unit as is known in the art. This date information is relevant to the transaction yield determination because rewards programs and their respective yields change by category, often throughout the year. Without proving the date, it would be impossible to prove what rewards rate to apply to a category of purchase for many transaction vehicles.

The final data input required to calculate the Account Rewards Factor is the Consumer Qualifying Information 2037. This qualifying information is made up of several variables all of which determine whether a consumer is eligible to receive various bonuses or deductions from his/her Account Rewards Factor. For example, if a consumer has owned a transaction vehicle for more than one year, some Rewards Programs may provide a bonus reward factor for this consumer on each transaction. The Consumer Qualifying Information encompasses all such data points, which include tenure, interest owed, account standing, and others, necessary to compute the bonus or deductions from the Account Rewards Factor. It is understood that more possibilities for qualifying information exist than those listed. These data will be tied to each consumer's individual record in the Consumer Demographic Storage Unit.

These data encompass the complete set of required information to compute the Account Rewards Factor. When all of these data points are tied together, the system 700 can analyze and compute the rewards return to be generated for a specific transaction.

The third and final component of calculating a transaction yield is to determine the Consumer Preference Exchange Rate (S205), which requires the collection of four pieces of data. The purpose for determining the Consumer Preference Exchange Rate is to account for the fact that different consumers value different types of rewards. One example is as follows: If the Starwood Preferred Guest American Express offers a higher rewards rate than other cards for a particular purchase, but the individual consumer using the present invention has zero interest in staying at a Starwood hotel, the higher rewards rate should be irrelevant to the consumer's decision. The Consumer Preference Exchange Rate takes that and other similar situations into account. For a more detailed explanation of the Consumer Preference Exchange Rate, the four types of data collected for this component are further described below.

The first piece of data, the Rewards Point Value, 2051, converts, for example, 10,000 Starwood points or 15,000 Delta air miles into cash equivalents. Either constantly or on a periodic basis, the present invention collects data offered publicly by e.g., Delta and Starwood, to determine how much value their points carry. As stated previously, this data collection and curation can be done via web spiders or other automated means. A specific example would be: web spiders collecting data from spg.com that indicate the point value and cash value for a basket of stays at hotels around the globe. The system 700 looks up to find that, for example, one night free in the Westin Excelsior Rome costs 20,000 bonus points, whereas the cash cost is $500 per night. The system collects data for the basket of different hotels around the globe, which the Transaction Vehicle Personalization Storage Unit then utilizes to compute the average dollar value of a single point, or 25 cents in the illustrative example above. Similar such collection and computation processes would be undertaken for each of the major currencies in the rewards point universe.

Second, the consumer's unique preferences must be accounted for at step 2053. The present invention decomposes consumer preferences into four primary categories: cash-back, rewards points, air miles, and hotel points; these categories can change as issuers and merchants change loyalty program reward types or as program rewards criteria change. It is possible that more categories could exist over time, including alternative currencies or rewards related to, for example, Facebook Credits or Bitcoin. In effect, an individual's preferences create an exchange rate pertaining only to that individual. The exchange rate represents the degree to which an individual prefers one form of rewards over another, for example a consumer could prefer cash-back to hotel points by a 3:1 ratio. If that example were true, the consumer would not accept a hotel point unless it was worth greater than three times the cash rewards available. The present invention has the ability to capture consumer preferences, translate preferences into an exchange rate, store the exchange rate, and apply the individual consumer's own exchange rate to a personalized transaction yield determination. Additionally, as the user's goals change over time, such as his or her family decides to take a trip, the exchange rates can be altered for a defined period of time, until the event happens. Once the event has occurred or appropriate time has passed, these preferences-revert to normal. The user can control and communicate his/her preferences and goals to the system via a consumer device.

Unlike other forms of data that are gathered or updated each time the present invention is utilized, Consumer Preferences are set during enrollment and can be changed by the user at any time they please, but the user is not directly prompted to do so during each use of the invention. The questions asked about a consumer's preferences imply an exchange rate that is applied to the aforementioned Rewards Point Value. The exchange rate indicates the relative premium or discount a consumer places on a specific type of reward, thus accounting for consumers who do not intend to take an air plane trip for which air miles would be useful or consumers who, for example, do not like staying at Starwood hotels while on vacation.

The third variable 2055 to account for is a consumer's transaction vehicle ulterior benefits preferences. Oftentimes transaction vehicle accounts come with benefits that are not specific to the transaction vehicle itself, such as access to airport lounges, extended warranties on items purchased using the transaction vehicle, support in disputes with merchants, and enhanced customer services such as concierge services. These factors, while not germane to a particular transaction or merchant, can influence the usage habits of consumers. As such, the present invention has the ability to account for these nuances in an automated processing system and method. An example of this would be if a consumer was at an electronics retailer purchasing at TV, a warranty may be more preferred by the user; therefore, if a card provided an extended warranty, the Transaction Yield Personalization routine would automatically assign a value, as prescribed by the user's preferences, to that warranty in processing the transaction yield. Therefore a relatively low direct transaction yield can be ranked higher than another card by the present invention because of the advantages that accrue to the user as a result of ulterior transaction vehicle preferences 2055.

The fourth and final component of Consumer Preference Exchange Rate is a consumer's own goals, 2057. The present invention allows the user to establish goals, for example take a trip to Europe on points or accrue $1,500 of savings toward the purchase of a new computer. Taking these goals into account, the present invention personalizes which transaction vehicle is used by automatically storing the value 2057 accrued on the user's profile. Therefore, as rewards are accrued and before they are redeemed, the present invention can display user's progression toward each of their stored goals 2057. Additionally, these goals may be shared across multiple users in order to accelerate the progress toward a communal goal.

Each of the three variables, Transaction Amount 201, Transaction Vehicle Account Rewards Factor 203, and Consumer Preference Exchange Rate 205, must then be multiplied against one another, the product of which is the Personalized Transaction Yield 207. The Transaction Amount is any value that is the result of adding up the price of each of the items being purchased by the user. The Transaction Vehicle Account Rewards Factor is an amount between zero and one-hundred percent that is the reward being offered by the transaction vehicle issuing institution, as captured by the web crawlers. Lastly, the Consumer Preference Exchange Rate is some value between zero and one-hundred percent that is determined based on a user's preferences versus the reward being offered. Thus, when the three amounts are multiplied, the product is just like any typical cash back process, for example, ten dollars multiplied by 5% cash back, adjusted by some percentage value based on the consumer's preferences.

Personalized Transaction Yield S207 can be displayed to the user either as a score, such as a 1-100 ranking, a letter grade scale, or it can be displayed as a numerical value representing the dollar amount of rewards or savings accrued by the user for each of the one or more payment vehicles adjusted by that user's preferences. It is possible to produce a similar result for the user using a slightly different mathematical formula or slightly different mathematical operations such as those described above; therefore, people moderately skilled in the art may be capable of delivering a similar value proposition with slight changes to the methods and system described herein.

In summary, each of the three components of the Personalized Transaction Yield plays a critical role in calculating the estimated transaction yield for a transaction vehicle and thus the recommendation delivered by the present invention. The output of the Personalized Transaction Yield Personalization 207 explained in FIG. 2, is that the present invention displays a ranked list of potential transaction vehicles, sorted in descending order to ensure the most valuable transaction vehicles and their respective transaction yields are displayed.

FIG. 3 is a specific example of how the present invention functions in the case of Static Transaction Vehicle Rewards Personalization. As illustrated, there are three elements involved in making the present invention function, the user, the process, and the system. For the purposes of this example, specific references will be given; however, given that this is merely one illustrative example of how the invention creates an output, this is by no means a limitation to the scope of the invention.

By way of example, assume a user has a goal of taking a family vacation to the Bahamas and wants to use air miles and hotel points to defray the out of pocket costs of the trip. Prior to executing the process described in FIG. 3, the user creates a goal in their account profile into which, for example, air miles generated as rewards are “deposited” directly as they are accrued. The user can track over time as rewards accrued and deposit into their goal accounts. There are a plethora of possible options for goals including a new house, car, paying for an education, paying for a family trip, charitable donations, and so on.

Step S301 is initiated when the user enters a merchant's physical or ecommerce location, for example a Best Buy store. Subsequently, in step S303, the user employs their consumer device to launch computer executable code. For example, the user's code could be launched from a computer application, a mobile website, or cloud-program accessed via a user device, all of which are collectively referred to as the “program”. In step S305, the program enables the user to check-in to the merchant electronically, declaring to the program the merchant in which the user is located. In the subsequent step, S307, the program accesses the Merchant Industry Identification Information 2033 for Best Buy, an electronics retailer, which falls into Merchant Category Code 5732 for Electronics Stores. Within this step, the program performs two functions: 1) Map the Merchant Industry Identifying Information to a Merchant Category, and 2) Reference the merchant's Merchant Category to the Merchant Category Code 2033. The storage unit containing the Merchant Categories and their respective codes is contained within the Transaction Vehicle Personalization-Storage, MCC component 811 in FIG. 8. For instances in which a merchant's category might not be obvious or is unknown, the invention may call a third-party API that contains the information-or look up the first four digits of the merchant's SIC or NAICS code as previously explained. Next, in step S309, the invention asks the user if they desire to publish their check-in to a social network. An option exists in the program's settings function that allows the user to always publish or not publish check-ins, making each future instance of a user's experience slightly easier to execute. For example, a user who chooses to have his/her check-ins published automatically would select such a choice from a pre-provided selection of settings. Upon making this selection, each subsequent time the user checks-in the check-in could be published to a set of social connections established natively within the application, or established on some other social network. Step S311 obtains the transaction amount of the purchase in question. In the static process as described in this example, there are two options for how the transaction amount is obtained: 1) the user can enter the transaction amount themselves, so that the program can calculate the exact transaction yield, or 2) the user may choose to employ an assumed value of, for example, $40, which is approximate to the average transaction size on a credit card. Option two produces a relative ranking of credit cards, but is not-sufficient to calculate the exact transaction yield. In this example, let's assume the user has decided to purchase a television valued at $2,500. The user keys in the value of $2,500 into their consumer device when prompted by the program, or it could be automatically entered via communication with the PoS. Subsequently, in step S313, the system captures the value entered by the user and inserts the transaction value into the processing steps that the Merchant Industry Identifying Information is entered into. Next, the system determines, at step S315, the personalized transaction yield for over 50 different credit cards and charge cards, as contained in the Transaction Vehicle Personalization-Storage Unit 703. The method and system together calculate, as described in FIG. 2, the return for each of the credit cards based on 1) the rewards programs of each, 2) the merchant in question (e.g. Best Buy), 3) the current date, 4) the transaction amount as entered by the user (e.g. $2,500), 5) cash value of any rewards points, for example the AmEx Gold Card's points or the AmEx SPG card's points, and 6) the consumers preferences and goals for accruing cash-back, hotel points, air miles, reward points, and for ulterior card benefits. Once the method uses the system to calculate the transaction yield of the plurality of choices, the system creates a display of, for example, a set of five cards. The next step, S317, is specific to the user's possessed set of transaction vehicles. Depending on the number of transaction vehicles the user uploaded to the system, the system indicates a minimum of one and a maximum of five of the user's possessed transaction vehicles and the personalized transaction yield for each respective vehicle. If the user has uploaded equal or greater than three cards, the system will indicate the user's top two cards, according to the yield, as well as their worst card; outside of the three possessed vehicles, the system will display two vehicles the user does not possess, if there exist vehicles that provide a greater yield than those the user possesses. The display will also have the ability to be expanded and contracted, in the case that a user's best and/or worst vehicle falls outside the top five possible vehicles. In the case that the user possesses the top four or top five transaction vehicles, the system will display four or five possessed vehicles, and one or zero vehicles, respectively, that the user does not possess. It is understand that while the above example describes a single embodiment of the present invention, other sequences of the same set of actions, data calls, and processes are encompassed by the current description.

To provide an example of how the system implements step 317, the user sees an American Express SPG Credit Card and an American Express Gold Preferred Rewards Charge Card, neither of which the consumer owns and each of which provide the consumer a greater yield than any card he/she currently possesses; the system-also displays three cards the user does possess, such as a Chase Freedom-credit card, a Discover More credit card, and a credit card issued by a local bank displayed in descending order with the personalized transaction yield for each. Once the user has viewed the display presented in step S317, the user can choose to either end his/her session with the program and pay for the purchase with one of the recommended cards, or the user can investigate one or more of the many credit cards listed in the display. The main reason why a user would choose to investigate the other credit card options is because those cards could have yielded greater rewards to the consumer for that transaction than any vehicle he/she possesses. For example, if the consumer only has a Chase Freedom card and it generates $35 in consumer rewards for the purchase of a TV set, but another card, the Discover More card, yields $125, the consumer has effectively foregone $90 of rewards on that transaction. Therefore, the consumer may choose to investigate the details of the Discover More card in step S319. By choosing the investigate the Discover More card in greater depth, the consumer, in step S321, would click on the Discover More card button in the program interface. Subsequently, the system, in step S323, will display an overview of the Discover More card's program details, including annual fees, rewards program details, ulterior benefits, APR ranges, and other attributes. At this point, the user reads through the details about the Discover More card and chooses to apply for the card, step S325. After selecting the apply button, the user enters their personal information, including name, address, annual income, social security number, and other information required by the credit card companies to evaluate an application, step S327. As part of S327, the system has the capability to store the information should the consumer so choose, so that future applications can be done in a matter of a few seconds. If stored, the data is stored on a secure server, and the user assigns a Card Application Personal Identification Number (PIN). After having entered their personal information into the application screen, the user-again selects the apply button. At this point, the system prompts the user to enter his/her Card Application PIN; once entered, the system processes the credit card application with Discover directly, step S329. Once the application has been filed with the appropriate issuer, the process ends by the user closing out this instance of the application on their consumer device.

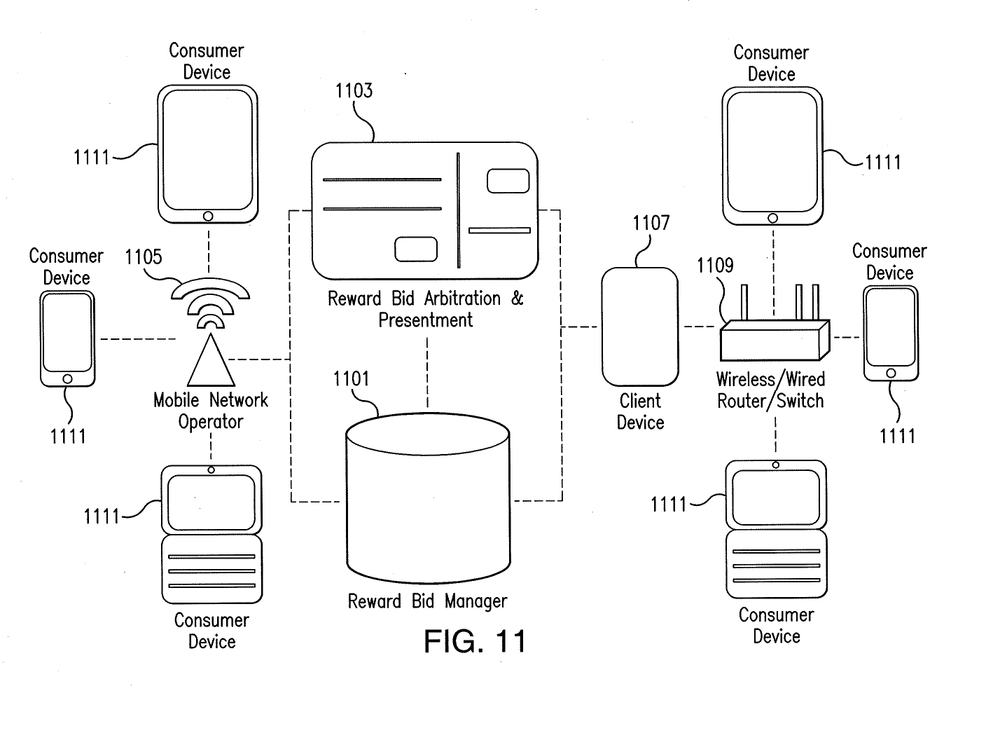

Data gathered throughout the course of, for example, a month's transactions would be stored in the memory of the consumer device or in the Transaction Vehicle Personalization Storage Unit 703, thus enabling the user to evaluate their spend over that time period. In further embodiments, this data is stored in the Transaction Details and History Storage Unit, as described in FIG. 11.

### B. Transaction Vehicle Yield Personalization and Payment Processing During Dynamic Transactions

The following embodiment describes the systems and processes by which transaction vehicle yield personalization occurs for a dynamic transaction. By definition, a dynamic transaction is one in which mobile checkout is enabled. Mobile checkout is a situation in which the consumer does not need to remove a card from his/her wallet, but can simply tap a button on his/her phone to confirm a transaction, or put his/her phone within some distance of a receiver that reads the card information securely via remote communication technology, such as Near Field Communication (NFC) chips. Thus, in contrast to the previous embodiment, Real-Time Auctions for Personalized Rewards Bid with Static Processing, the present embodiment will describe the set of systems and methods used to achieve the same result in a situation with mobile checkout. Prior art exists with regard to dynamic transaction processing systems, such as patent US2011/0078081 A1 issued to Pirzadeh and Kekicheff. Embodiments herein related to dynamic transactions build upon this prior art with novel features.

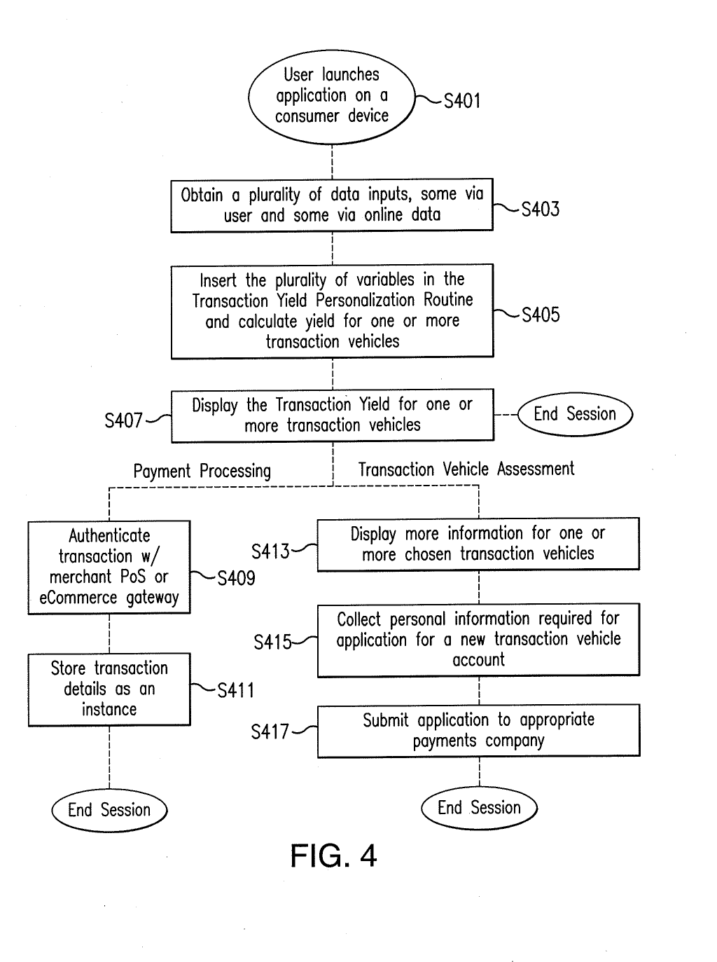

FIG. 4 represents a second embodiment set forth herein, which contrasts the embodiment described in FIG. 1. A difference between FIG. 1 and FIG. 4 is, rather than simply processing a recommendation regarding which transaction vehicle should be employed to the consumer, the system automatically processes the transaction on the transaction vehicle account that would create the greatest transaction yield for the consumer. The invention does so by utilizing existing mobile checkout technology, and can utilize any evolution of such technology invented in the future.

Steps S401, S403, S405, and S407 are similar to steps S101-107 described in FIG. 1. FIG. 5, as will be provided in more detail below, describes slight variations to how the data are collected, the granularity and fidelity of data, and how the outputs are used relative to FIG. 2.

Step S407, ends with the present invention displaying the personalized transaction yield for one or more Transaction Vehicles, (as described in the S104 definition above). In FIG. 4, however, rather than advancing to a-screen with more information, step S409 establishes a secure connection between the consumer's device and merchant's PoS or other transaction processing system. After the secure connection has been established, the consumer's device authenticates the identity of the consumer device's user so that payment can be made via the above-noted software application. Authentication can take numerous forms, including simple buttons to approve a payment, passwords or PINs, or voice recognition, fingerprint, or facial recognition biometrics. Step S411 concludes by storing a log of the transaction in the systems proprietary memory.

Subsequent to a positive authentication response being received by the merchant's PoS, the merchant's PoS system or similar system submits the payment transaction to the merchant's payments processor. At this point, the transaction is executed through the traditional payment authorization and settlement process as described in the section detailing the background of the invention.

Data captured during this process would also be stored in the consumer device's memory or the Transaction Vehicle Personalization-Storage Unit 703, enabling analysis of personalized transaction yield on a historical basis, for example over the course of a month.

FIG. 5 illustrates the process called the Transaction Yield Personalization (TYP) routine, by which transaction yield is determined for a given transaction vehicle and transaction. As with FIG. 2, there are three main components to the TYP: 1) Determination of a Transaction Amount (S501), 2) Determination of a Transaction Vehicle Rewards Account Factor (S503), and 3) Determination of a Consumer Preference Exchange Rate (S505).

These three components 501-505 have the same types of inputs, outputs, and objectives as the corresponding elements 201-205 shown and described in FIG. 2. However, differences arise in how the data are collected, granularity and fidelity of the data, and how the data are put to use. All of the variables are the same, however. For the purposes of describing FIG. 5, assume that all functions, variables, and methods are the same as FIG. 2, unless specifically described below.

The first difference is shown in S501, the determination of the transaction amount. In the dynamic process, the data for S501 are obtained automatically via communication with the merchant's PoS or gateway system, not keyed in by the user or assumed, as in FIG. 2. Additionally, S501 will collect significantly more granular and higher fidelity data from the merchant than simply the transaction value, including SKU level information about which products have been purchased. A SKU is a unique identifier, typically a combination of alphanumeric symbols, assigned by a merchant to an item for the purposes of data management. SKUs are determined independently by each merchant, and therefore are not a unified method for identifying a specific item within the marketplace. During any transaction, as a merchant records the items being purchased in the transaction, the merchant POS collects the SKUs in the purchase basket. This allows the merchant to record total sales, track inventory requirements, and project future buying needs, as well as perform a number of other helpful business functions.

In the recommended form of the present invention, SKU-level data including SKU price, quantity, type, style, size, color, model, and other product attributes and metadata are collected and passed through to the present invention. The present invention could also employ a software program running on the merchant's PoS or gateway to collect the aforementioned data, or the present invention could replace the merchant's PoS or gateway, which would remove unnecessary intermediaries from the payments authorization and settlement processes.

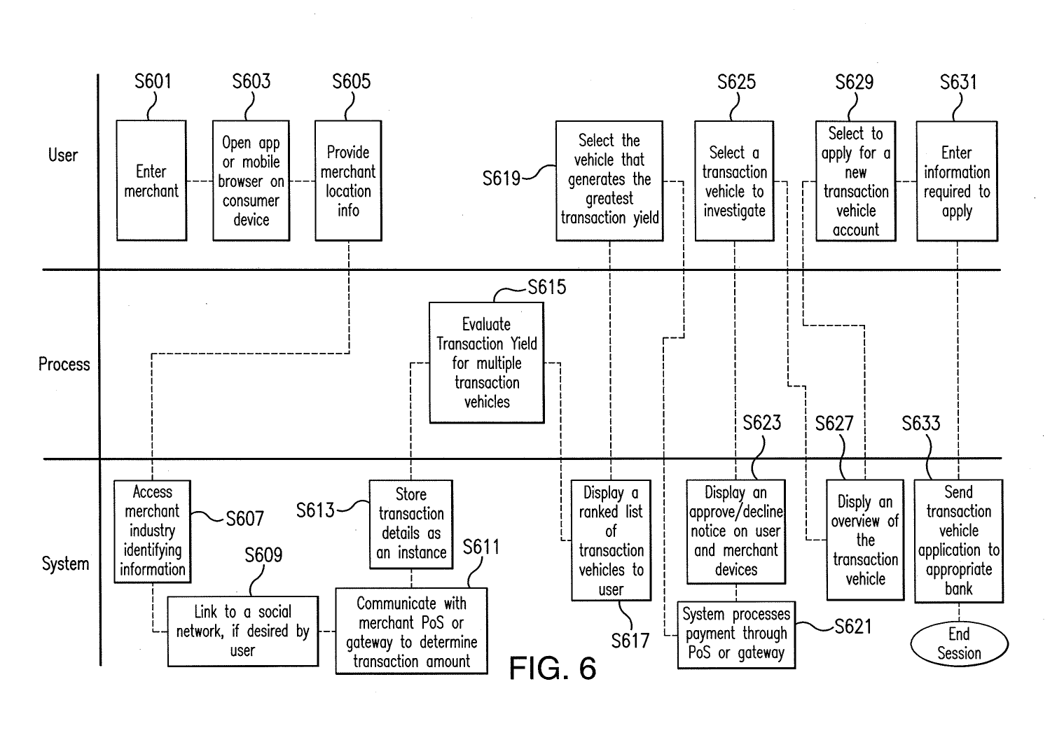

The second and final difference between FIG. 2 and FIG. 5 comes in how the data are utilized once the personalized transaction yield has been calculated. Whereas in FIG. 2, once the personalized transaction yields are displayed by the present invention on the consumer's device, the user must then physically swipe the recommended transaction vehicle, the present invention described in FIG. 5 takes the outputs and automatically processes the payment via mobile checkout technology, as shown in FIG. 4, step S409. The example described subsequently in FIG. 6 will illustrate a concrete instance of the invention described in FIG. 4 and FIG. 5.

FIG. 6 illustrates a specific example of a user performing the Dynamic Transaction Vehicle Personalization process. For the purposes of this example, the user is making a purchase at an ExxonMobil gas station. As with FIG. 3, FIG. 6 has three interacting parts: the user, the process, and the system. Also, in this example, assume that the user has decided to create a goal to save up cash-back rewards earned from their purchases in an account that will be put toward their child's college education.

Starting with step S601, the user will initiate a potential transaction at an ExxonMobil station by pulling up to a gas pump in their car. Once arriving at the pump, the user will launch computer executable code on their consumer device, step S603, which could be a smartphone, tablet, an in-car interactive display or any other conventionally known computing or logic device. The computer executable code could take the form of an application or a mobile website. In either case, the user checks-in, step S605, to the gas station, which, by establishing a secure Internet connection with the gas station, notifies the attending gas station clerk of the pump location of the user. When the secure Internet connection has been established with the gas station, the user can begin pumping fuel. Once secure check-in has been completed, step S607 begins immediately thereafter with the system accessing the Merchant Category Code 2033 for ExxonMobil, which is 5983 for Fuel and Liquefied Petroleum. This categorization is stored in the Transaction Vehicle Personalization-Storage Unit. In instances where the MCC 2033 is not obvious or unknown, a third party storage unit can be accessed. Once the Merchant Industry Identifying Information has been collected, step S607 closes. Subsequently, S609 begins as the system then offers the user the choice to publish their check-in or purchase to a social network. As with the description of FIG. 3 of the static personalization process, the dynamic process also allows the user the option to choose whether or not to automatically approve or decline social media sharing for the purpose of user ease. Once a decision has been made about whether or not to post to a social media site, the process proceeds to step S611. Once the user has finished pumping fuel, the program communicates with ExxonMobil's PoS system, gateway or other system to determine the transaction amount. The system then stores a log of the transaction in step S613. Almost instantaneously, the program calculates personalized transaction yield, step S615, across a multitude of possible transaction vehicles. At step S617, the analysis includes both accounts that the user possesses and accounts that the user does not possess. Within a moment the analysis is completed, using the variables described in FIG. 3, and the system displays the transaction vehicles in the manner described in step S317. As described, at least one of the five displayed transaction vehicles is possessed by the user, because step S619 requires that the user select the transaction vehicle that he or she wishes to use to pay for the transaction, and the program recommends the account that generates the greatest personalized transaction yield, taking into account the user's goal of saving for their child's college education. Once the transaction vehicle has been selected, the system-automatically processes the payment, step S621, through the merchant's PoS or Gateway or other system, using the previously established secure connection. In step S623, the system displays an approval or decline to both the user's consumer device and the merchant's interface. The consumer-automatically has a receipt stored on their user account profile, and one can be emailed or otherwise communicated electronically to them if they so choose. After the approval or decline has been provided, the user may close their session, or they may choose to evaluate a transaction vehicle that could have yielded a greater dollar value, as per the program's insights in steps S615 and S617. If the consumer's credit card is listed fourth on the list of five, then the user is still required to use the fourth card, because they do not possess the specific transaction vehicle offered by the first three issuers. However, a consumer may decide that acquiring a card issued by one of the first three payments companies may be advantageous. In this case, assume that the card with the highest personalized transaction yield was an ExxonMobil Citibank card, which offers 15 cents back per gallon. If the user purchases ExxonMobil gas on a regular basis, they may be interested in applying for that card. If the consumer indeed decides to evaluate this transaction vehicle, he/she then selects the ExxonMobil card-on the user interface as part of step S625 is initiated. Subsequently, the system displays a profile of the ExxonMobil card, describing relevant offer details, such as rewards rates, APRs, annual fees, ulterior benefits, or other stipulations of the account agreement, step S627. If the user found the card profile to be advantageous, then he or she could select the apply button on the user interface to apply for the card, step S629. During the first instance in which the user applies for a credit card using the program, the user is required to enter the usual personal information required to complete a credit card application, step S631, including but not limited to data such as: Name, Address, Date of Birth, Email, Phone Number, Annual Income, Occupation, Employer, Time at Job, Social Security Number, and other security information. The user has the option to store their personal data, so that future instances using the program to apply for a transaction vehicle require a shorter process. In such cases, the user-simply needs to enter a Card Application PIN that they have self-input, as described in S329. Lastly, to close the application process, step S633 is initiated. In this step, the system sends the payment vehicle application to the appropriate payments company on behalf of the consumer. Once the application has been submitted, the session is completed.

FIG. 7 depicts an architectural diagram of an embodiment of the system employed by the present invention. The main element of the system is component 701, the Rewards Personalization Engine (RPE). The RPE is the centralized computer (or computers) that collects, stores, and processes data in real-time to provide recommendations to consumers. Alternatively, the RPE can be a distributed computer architecture or even a cloud processing environment. Other conventionally known computer architectures can be utilized as the RPE. Components 707, 709, and 711, Mobile Networks, Client Devices, and Wired or Wireless Routers all provide a means for the RPE to collect, store, and interpret data. Consumer devices such as mobile phones, PDAs, Portable Media Players, tablet computers, laptops and desktops all can interface directly with components 707, 709, and 711, which in turn send data to the RPE. On the back end of the RPE is the memory infrastructure called the Transaction Vehicle Personalization Storage Unit (TVS), component 703, capable of housing and interpreting the data sent to it. FIG. 8 further displays the specifics of the memory 703. Lastly, the Merchant Terminal, component 705 such as a PoS, interacts directly with the RPE in cases in which the transaction is directly processed via the present invention as previously described in FIG. 6.

FIG. 8 depicts an embodiment of an architectural arrangement of the hardware and software components for the Rewards Personalization Engine and the Transaction Vehicle Personalization routine. Together the components of the present invention referenced in FIG. 8 comprise the Transaction Vehicle Personalization-memory (TVPD) 703. There are six main storage units that are linked to the TVPD 703: 1) Consumer Transaction Vehicle Account Storage 803, 2) Consumer Transaction Vehicle Application Storage 805, 3) Consumer Preferences Storage 807, 4) Transaction Vehicle and Rewards Program Storage 809, 5) Merchant Industry Identifying Information Storage 811, and 6) Rewards Points Values Storage 813. Each memory or storage unit has access to a central processing server equipped with one or more microprocessors 815, communications ports 817, input devices 819, ROM 821, RAM 823, a display 825, and web spiders 827 for data collection and curation. In an alternative embodiment, the storage shown in FIG. 8 can be combined into a single memory, or in yet another embodiment, remotely stored in a cloud storage environment. One database can be associated with a single storage unit or multiple units to manage the data. Conversely, multiple databases can be associated with a single storage unit.

Below is an elaboration on the data contained within and purpose of each of the six aforementioned memories: First, the Consumer Transaction Vehicle Account Storage-803, captures and stores the specific Transaction Vehicles each user possesses. An example would be Jane Doe has an American Express Gold Premier Rewards charge card, a Chase Freedom credit card, and a Starwood American Express credit card. Data in this memory are populated and maintained by consumers themselves; however, in situations where the system automatically applies for new cards as instructed by the user, it can automatically add them to a user's profile.

Second, the Consumer Transaction Vehicle Application Information 805, contains highly confidential personal data and is used to accelerate the transaction vehicle application process as shown in FIG. 1 and FIG. 4. The data for this memory are populated and maintained by consumers, and secured with industry standard Secured Socket Layer (SSL) encryption technologies. Card Application PINs are also used to ensure the fidelity of the process.

Third, the Consumer Preferences Storage, component 807 captures both Exchange Rate and Ulterior Benefit preferences that were previously discussed in the description of FIG. 2 and FIG. 4. This information is populated and maintained by consumers.

Fourth, the Transaction Vehicle and Rewards Program Storage-captures and stores data related to the universe of transaction vehicles and their respective rewards programs. A specific example of this information is the rewards categories, applicable dates, and spending limits that are part of the Chase Freedom and Discover More Cash Back cards. This information is captured from the websites of the various issuers and curated by web spiders or other automated data gathering processes conventionally known in the art.

Fifth, Merchant Industry Identifying Information is captured-through one of the-methods explained in FIG. 2 and FIG. 5. These data are curated in the preferred embodiment by web spiders or by other automated means.

Sixth, the Rewards Points Value Storage captures and stores the monetary value that is associated with various types of rewards points. A few specific examples include the dollar value of one American Express point, Starwood Preferred Guest point, or a Delta Sky Miles point. These data are obtained by comparing various bundles of redemption options, known as baskets, such as how many points and dollars it would cost to purchase a first class ticket to Rome, stay in a four star hotel in Paris for two nights, or purchase an iPad on American Express Membership Rewards Points. Each of these scenarios has a point cost and an implied cash value. By analyzing bundles of these options or “baskets”, for which data could be collected, the system can ascertain the average value of a single unit from each respective point program, such as an air mile, hotel point, or rewards point.

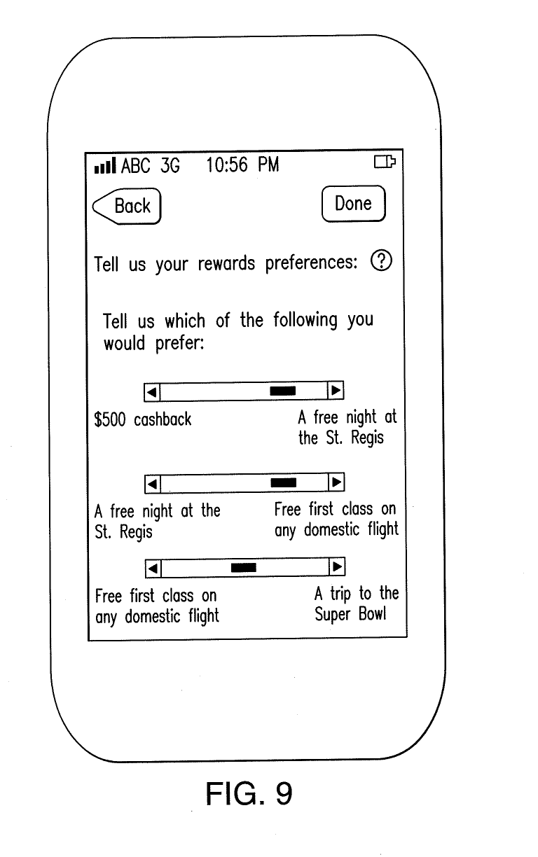

FIG. 9 is a view of a user interface that captures the rewards preferences of an individual, which communicates with the Transaction Yield Personalization routine described in FIG. 2 and FIG. 5 and subsequent descriptions. A user's preferences are stored in the Consumer Preferences Storage 807 described in FIG. 8 according to its definition. Data captured from this user interface are critical in determining an individual's Consumer Preference Exchange Rate S205. Different combinations of options will be presented to the user to determine the consumer's bias for or against cash back, rewards points, air miles, hotel points, other forms of rewards, or ulterior benefits. One specific example of options included is $500 cash back vs. one free night in a four star hotel in Rome, the two of which would have an equivalent monetary value. Based on the degree to which the user prefers one option to another, the System will adjust the consumer's Preference Exchange Rate, indicating that, for example, a consumer values receiving cash-back more than rewards points. Aside from monetary choices, the present invention also presents non-monetary choices such as importance of customer service or extended warranties for certain types of purchases. A specific example of this was contained in the description of FIG. 2 and FIG. 5. The severity of preference is prescribed by the consumer in accordance with choices made on the Preference Selection Tool 901 illustrated in FIG. 9.

Once the consumer's preferences are captured, typically during the enrollment process, they can be accessed and updated whenever the consumer chooses to do so. This interface is displayed on the consumer's device and data is stored in the Transaction Vehicle Personalization Storage or locally on the consumer's device.

FIG. 10 is a view of a user interface that displays the personalized transaction yield for a plurality of cards on a single purchase. This view is the intended outcome from the present invention, as it completes the goal of providing a specific recommendation to the user regarding which transaction vehicle generates the greatest return based on their preferences. FIG. 10 depicts the rewards return for a single transaction. In addition to this, the present invention also possesses the ability to create a similar graphic on a historical basis. One specific example of the historical view could be when a user desires to understand, for example, which card products could have saved them the most money over the last month. Rather than depicting a single transaction, the interface would display a cumulative total for all transactions performed in the last month. Data for conducting such analysis would need to be obtained through third party transaction aggregation sources, a directly-uploaded data file of historical transactions provided by the consumer, or through transactions that were actually processed via the present invention, as described in FIG. 4.

### C. Real-Time Auctions for Personalized Reward Bids During Static Transactions

The previous embodiments described in FIGS. 1-10, provide a method for consumers to better understand transaction vehicle yields and select the vehicle most appropriate for them. As a result, consumers will become more cognizant of the need-for greater personalization in the way rewards are conceived and distributed. The following embodiments, illustrated in FIGS. 11-18 describe an evolution of this concept: in other words, a system and method to advise and instantly generate personalized rewards bids for credit issuers and arbitrate, present, and reconcile those rewards bids for consumers.

A rewards bid, as referenced in the present invention, is defined as any offer distributed by a rewards-issuing institution that is made up of some loyalty creating benefit; most notably, this includes the rewards currencies and ulterior benefits detailed in the aforementioned embodiments, such as hotel points, air miles, or purchase protection and warranty extension. Multi-transaction and graduating reward bids are included in this definition. A multi-transaction reward bid is one in which the reward only activates if a consumer conducts a series of transactions; for example, rather than offer 5% cash back for one transaction, an issuer could offer a more lucrative reward of 7.5% cash back if the consumer logs 10 or more transactions on a single type of purchase, say, consumer electronics. A graduating rewards bid is one in which the reward amplifies each time the consumer chooses to use that specific transaction vehicle; for example, a reward bid starts at 4% for purchases over $100, but increases in increments of 0.25% each subsequent time a consumer puts such a transaction on the same card. As a result, the fifth purchase receives 5% cash back.

Today, credit card issuers (which are a subset of the institutions that conceive and distribute loyalty rewards) devise their rewards programs independently and announce the rewards of a specific program through various methods, such as their website, direct mail inserts, or TV advertisements. As a result, the rewards offers are typically slow to change, not utilized in strategic ways, often forgotten about by consumers who have tuned out excess communication, and rarely targeted to specific consumer segments. For example, the rewards categories offered by the Chase Freedom credit card change every three months, but often are for categories of spend the consumer rarely frequents. Moreover, to activate the rewards, some banks require that the consumer go through a tedious registration process each time the reward categories are updated, typically monthly or quarterly.

FIG. 11 depicts an architectural diagram of an embodiment of the system employed by the present invention. The main element of the system is component 1101, the Rewards Bid Manager (RBM). The RBM is the centralized computer (or computers) and memory or memories that powers the system and processes information in order to provide reward-issuing institutions the ability to create, edit, and historically track rewards bids. Alternatively, the RBM can be a distributed computer architecture or-a cloud processing environment. Other conventionally known computer architectures can be utilized as the RBM as well. Components 1105, 1107, and 1109, Mobile Networks, Client Devices, and Wired or Wireless Routers collectively provide a means for the RBM to collect, store, and interpret data. Consumer devices such as mobile phones, PDAs, Portable Media Players, tablet computers, laptops and desktops all can interface directly with components 1105, 1107, and 1109, which in turn send data to the RBM. On the front end of the central system is the system and process called the Reward Bid Arbitration and Presentment-1103, capable of taking in data and interpreting from the RBM and consumer inputs in order to display a personalized reward bid to a consumer. The central system depicted in FIG. 11 is meant to be a supplement to the system described in FIG. 7. More specifically, the embodiment described herein provides systems and processes that replace the component 809 Transaction Vehicle Reward Program Storage that is a component of the TVPD described in FIGS. 7-8. This replacement is relevant and necessary because the system introduced in the present embodiment replaces the static rewards creation and distribution procedures followed by credit card issuers today; thus, web spiders or other automated collection methods are not applicable.

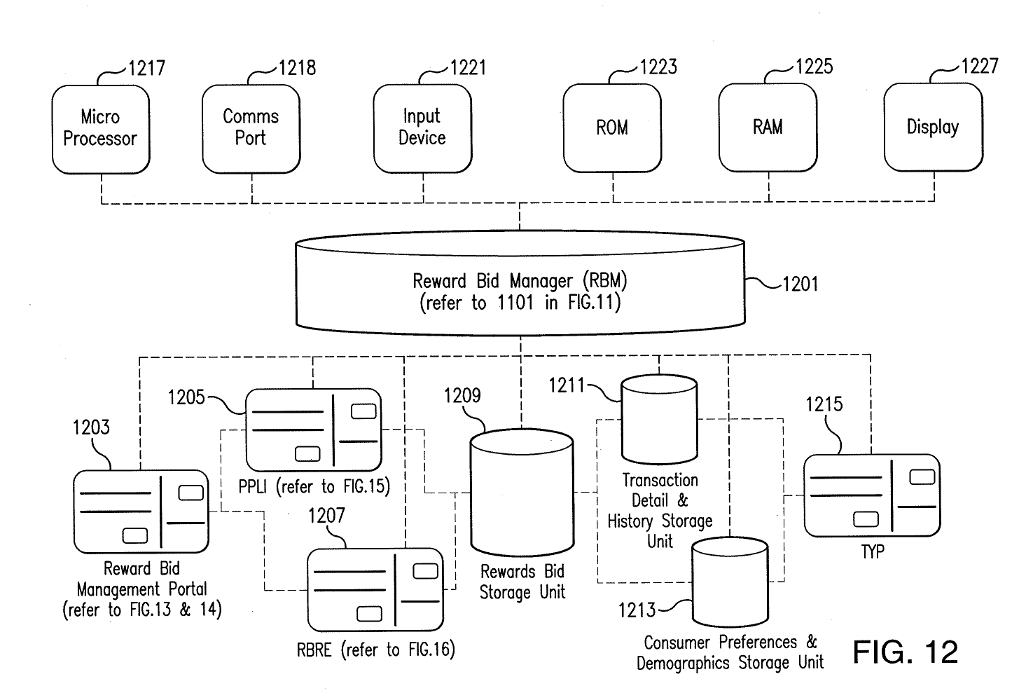

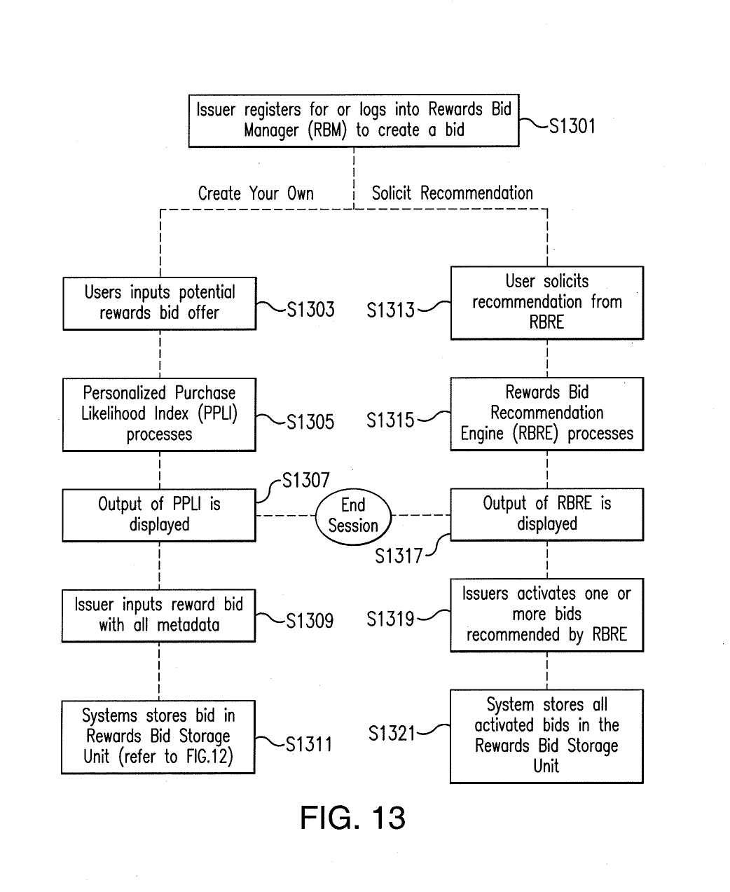

FIG. 12 provides a diagram of the architectural arrangement of the Reward Bid Manager embodiment described previously with reference to FIG. 11. Together the components of the present invention referenced in FIG. 12 comprise the Rewards Bid Manager (RBM) 1201. There are seven main components that are linked to the RBM 1201 that consist of memory or memories, processes, or web interfaces. Each will be described in detail in FIGS. 13-18, and comprise: 1) the Reward Bid Management Portal 1203, 2) the Personalized Purchase Likelihood Index (PPLI) 1205, 3) Rewards Bid Recommendation Engine (RBRE) 1207, 4) Reward Bid Storage Unit 1209, 5) Transaction Detail and History Storage 1211, 6) Consumer Preference and Demographics Storage 1213, and 7) Transaction Yield Personalization (TYP) 1215. Each memory or storage contains access to a central processing server equipped with one or more microprocessors 1217, communications ports 1219, input devices 1221, ROM 1223, RAM 1225, and display 1227. In an alternative embodiment, the Storage shown in FIG. 12 can be combined into a single storage unit, or in yet another embodiment, remotely stored in a cloud storage environment.

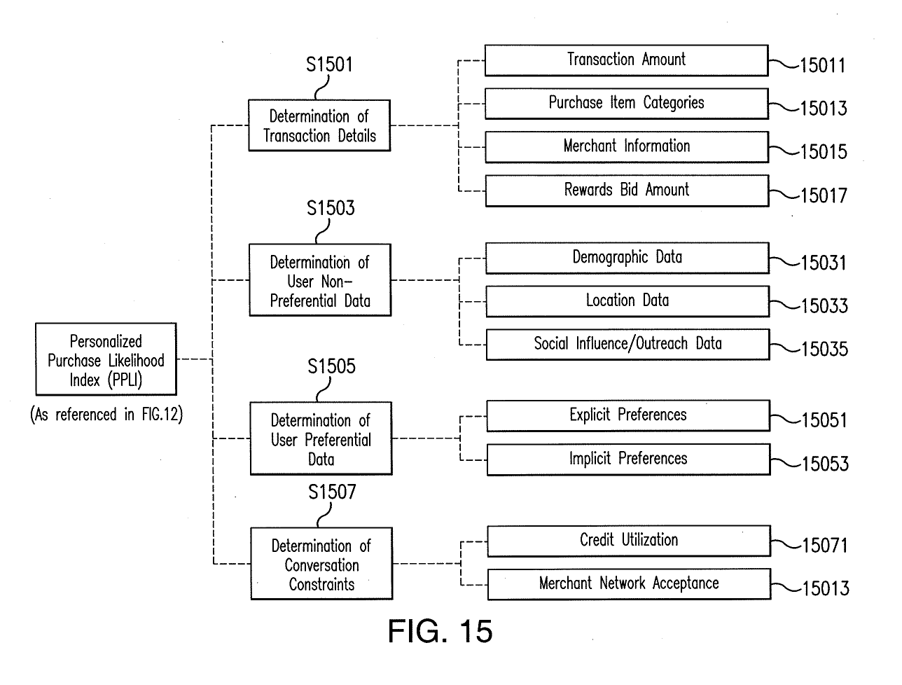

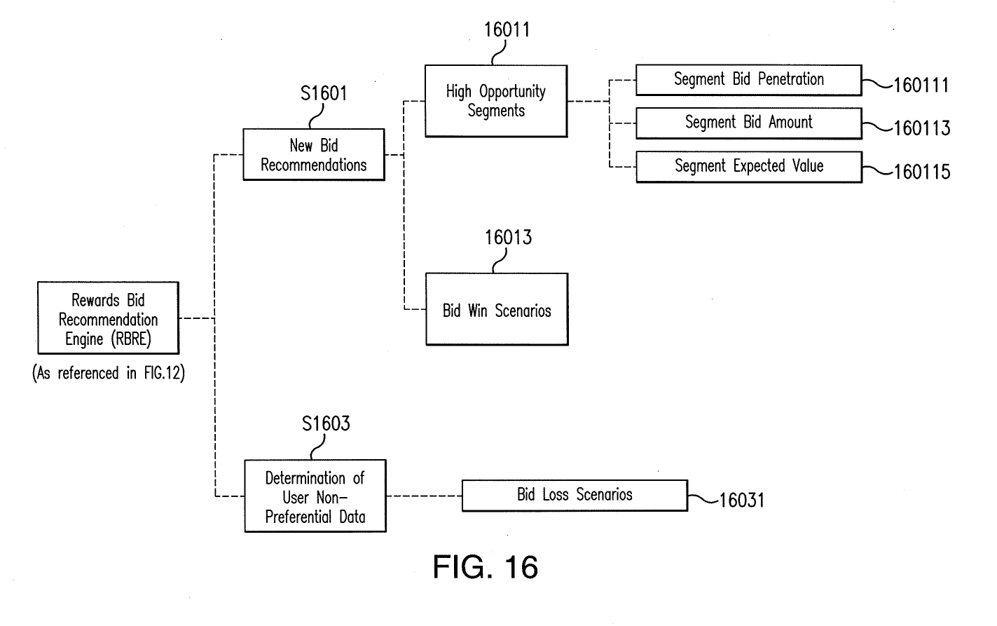

FIG. 13 represents a system and two methods that encompass the phase of the invention related to reward bid creation. The system, called the Rewards Bid Manager (RBM) is an infrastructure that includes front-end-interfaces as well as supporting computer hardware. There is a web portal for issuer-access, called the Rewards Bid Management Portal (RBMP), as well as a set of multiple memories that collect and store the relevant data the various systems and methods will access. Reward creation begins at step S1301, where the issuer signs into the RBMP, an encrypted portal accessible via multiple access points, such as a mobile device or personal computer, secured with Secure Socket Layer (SSL) encryption keys or any other conventionally known encryption technology. The RBMP requires a unique user name and password to access. If the issuer is new to the system, it will create its unique username and password in step S1301. Once within the RBMP, an issuer has the choice to create its own bid, or to solicit recommendations for a bid from the method and device called the Rewards Bid Recommendation Engine (RBRE) 1207 as depicted in FIG. 12 and described in FIG. 16. If the issuer chooses to create its own bid, the issuer has the ability to enter a potential rewards bid into the system in step S1303. In step S1305, the issuer can then utilize the method called the Personalized Purchase Likelihood Index (PPLI) 1205 in order to understand the likelihood that the aforementioned input bid will succeed in winning customers. The inner-workings of the PPLI are depicted and described in FIG. 15. The output of the PPLI is presented in step S1307. Utilizing the PPLI as an advisor, the issuer inputs the final rewards bid in step S1309. Once a bid has been input, it is stored by the RBM in the Reward Bid Storage in step S1311.

The RBM-allows for bids to be customized based on a plurality of data chosen by the issuer inputting the bid; first, the bid must be categorized as single-transaction, multi-transaction, or graduating reward type. Again, a multi-transaction reward is a bid that is only rewarded if a consumer conducts a certain transaction a specified number of times or in a certain pattern. For example, after five purchases at a specific grocery store, the consumer receives a five percent cash-back bonus on the amount of all five transactions; if he/she doesn't reach five transactions, no reward is distributed. Likewise, a reward could be given for a specified pattern, for example, every time a breakfast sandwich is purchased after a coffee. A graduating reward is a type of reward bid that provides the user a greater amount of rewards upon each time a user completes a specified action. For example, an issuer could provide a user a one percent cash-back bid the first time she makes a purchase at restaurants, two percent the second occurrence, and three percent for ongoing restaurant transactions. Further categories of data for customization are available when creating a bid as well, including user demographic data, transaction-specific details, user preferential data, and user social graph data, among others, all of which are accessed from storage accessible by the RBM. Other fields that an issuer can customize include conditional rules, such as the time period during which the offer is valid.

It is relevant to note how a multi-transaction or graduating reward bid functions, as both are simply single-transaction bids with more complex conditions. In the case of a multi-transaction reward bid, the real value of the bid on a per-transaction basis is zero. However, as each transaction is undertaken, the probability that the condition is realized increases, and thus the latent value of the bid increases. To accommodate this complication, the Transaction Yield Personalization (TYP) process is able to present the consumer a latent value approximation on a per-transaction basis. For example, if an issuer inputs a 5% cash-back bid to be rewarded only in situations in which a consumer buys consumer electronics 10 times using their transaction vehicle, the TYP would 0.5% for the first transaction, 1.0% for the 2^{nd} transaction, and so on. While this example over-simplifies the case, the present invention includes probability-based computations that adjust for a plethora of variables in order to present the most accurate possible latent value to a consumer. In the case of a graduating reward bid, the-bid is simply a computation of a mathematical sequence with an arithmetic progression. This type of mathematical sequence requires a base and an arithmetic increment; in the example of a graduating reward bid, the base could be a 1% cash back offer, with an increment of 0.5%. Thus, each transaction after the first would add the increment, such that the second transaction returns a 1.5% offer, and the third, a 2.0% return. With a base value and an increment, it is straightforward to calculate and present a graduated reward bid to a consumer on a per-transaction basis. As such, both multi-transaction and graduating bids are treated as a single-transaction bid for the remainder of this disclosure.

An example of when an issuer would use the RBM to create a bid, and how a specific rewards bid is entered in step S1309, is the following: CitiBank wants to acquire more recent college graduates, whom Citi believes will be an increasingly valuable segment of consumers, as customers of its “ThankYou” card; as such, CitiBank enters a bid to the RBM that specifies that whenever an individual of the ages 22-25 enters an IKEA store after graduation, say, between May and August 2012, CitiBank would offer 7.5% cash back. Such an offer would be an increase above the typical cash back rewards amount offered by other issuers for transactions at an IKEA store. The bid is input, and then stored in step S1311.

Another option the RBM offers to issuers is the choice to solicit a recommendation from the RBRE in step S1313. The RBRE is a method implemented by the system that is able to summarize and systematically learn from the performance of bids that have been created and presented by the present embodiment. The output of the RBRE includes recommendations for new bids that the issuer may want to explore, or changes to bids that the issuer currently has active in the RBM 1201. The RBRE method is described in detail in FIG. 16. Following step S1313, the RBRE processes potential new reward bid recommendations in step S1315. The system presents the output of the RBRE in step S1317. If the issuer finds one or multiple of the recommended bids to be favorable, it can choose to activate the bid, or bids, in step S1319. After the bid, or set of bids, is activated, the RBM stores the bid, or set of bids, in the Rewards Bid Storage Unit in step S1321.

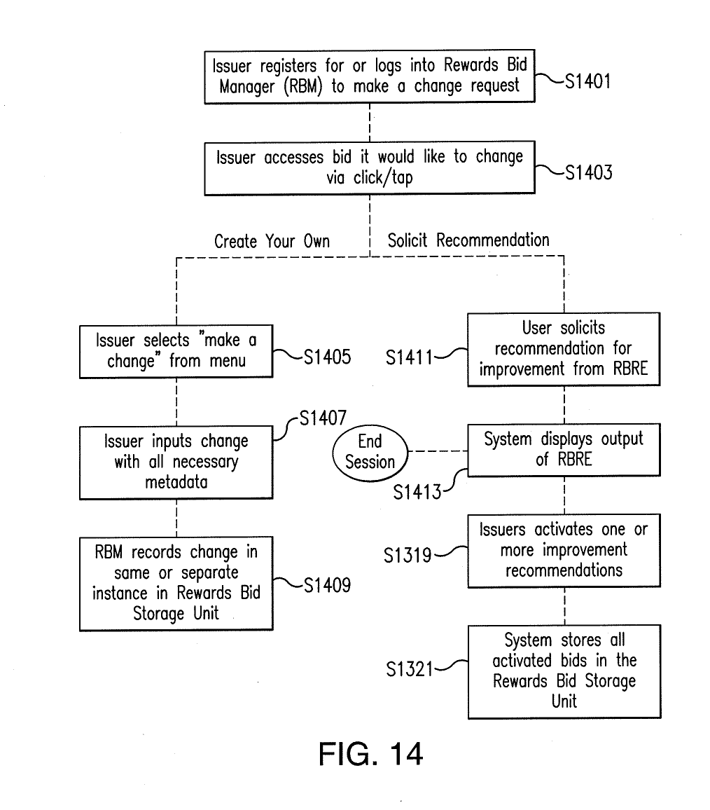

The process by which an issuer has the ability to make a change request, such as an edit to, cancellation of, or renewal of a rewards bid they have entered to the RBM, for any reason, is described in FIG. 14. To do so, the issuer begins in step S1401, by simply logging-in to the RBMP to access their unique account. This can be done via any consumer device that has Internet access or other WAN or Telco access, such as a mobile phone, tablet, or personal computer. Once logged-in, the issuer has the ability to view any current or past rewards bid entered into the RBM during the existence of its account. In order to make a change, first, the issuer must access the details of the bid it would like to change via a click of a mouse or tap on a mobile phone screen in step S1403. Here, the issuer has two options: 1) create a change, or 2) request improvement recommendations. In step S1405, the issuer can request to create its own change request by selecting the option to edit, renew, or cancel a bid. In step S1407, the issuer enters the desired change request and submits their change. The change is then logged in the Rewards Bid Storage Unit within the same instance or a separate instance in step S1409. If the issuer chooses to receive a recommendation, the RBRE processes in step S1411. The output of the RBRE is presented in S1413. An example of a potential improvement recommendation could be to change a current bid targeted at males aged 25-30 to target males aged 30-35, since the RBRE has calculated that this older segment is currently under-penetrated and thus more likely to choose the bid. If the issuer finds one of the improvement recommendations presented by the RBRE favorable, it can activate that change in step S1415. Upon activation, the system will store the change in the same or a separate instance in the Rewards Bid Storage Unit in step S1417.

If the issuer has created an edit of an existing bid, or renewed it exactly as it was originally entered just for a different time period, it will become an entry in the same instance. If, however, the issuer has renewed a bid as well as made minor edits based on insights they may have captured during the first campaign, or based on recommendations provided by the RBRE, that bid becomes a separate instance. On any future visit to their account, the issuer will be able to view any edits that have been made to a bid, if a specific bid has been renewed multiple times, or if a bid is a scion of a previous bid with minor edits. Hence, the RBM provides a detailed history of all bids created and changed over the course of the users account.

To provide an example of a change request, take the aforementioned-bid entered by CitiBank for males 22-25 at IKEA. Assume the bid is wildly popular with the target audience, and CitiBank wants to renew the bid for the following year, 2013. To do so, CitiBank would log-in to their account via some type of consumer device S1401, specify the bid that they would like to renew via a click or tap S1403, make the appropriate selections to renew the dates S1405 and submit bid S1407. Once entered the system would log the renewal as an entry in the same instance S1409, since the bid was an exact clone. Assume, however, CitiBank increases the bid to 10.0% cash back in 2013, versus the previous 7.5% offered in this bid. In this case, 10.0% is entered as a separate instance in the Rewards Bid Storage Unit. This concludes the creation and change request phase of a rewards bid in this embodiment.

FIG. 15 illustrates the process in which a Personalized Purchase Likelihood Index (PPLI) is developed by the system to advise reward issuers during the bid creation phase previously described in FIGS. 12-13. The PPLI determines the likelihood that a specific consumer in a specific situation will convert on a rewards bid; in other words, it is a personalized method for understanding consumer purchase intentions. Purchase, in the case of this system, will be defined as the act of a consumer making a purchase using a specific transaction vehicle; for example, the choice to purchase gasoline from Exxon Mobil on an ExxonMobil CitiBank Visa Card. Thus, the PPLI processes the likelihood that a consumer of some type and under some set of conditions will choose a specific transaction vehicle to make a purchase.

To demonstrate with an illustrative example, Discover may utilize the system to understand the likelihood that a 30-35 year old male with greater than $150,000 in household income per year uses his Discover “Free” card at an ExxonMobil pump if Discover provides a 2.5% cash back offer. Given that ExxonMobil CitiBank Visa Card offers 5% cash back, the PPLI may calculate that Discover will gain only one million of the twenty-five million forecasted transactions per year under the specified scenario. Said differently, the likelihood that such a consumer would use their Discover “Free” card would be one million over twenty-five million, or four percent.

The relevance of the PPLI in the scope of the present invention is that purchase likelihood is highly dependent on a rewards bid offer, and therefore, the information that the PPLI provides will be valuable for any issuer.

Prior to describing the components of the PPLI, two overarching rules must be explained. The first is the manner in which the PPLI processes. As described in the following paragraphs, the PPLI is a modular computer process and system in which an issuer can add or subtract any number of fields to the process or modules to the system, and change the value the field takes. Thus, the processing is customized such that an issuer is in control of the inclusion and value of all but one variable, which is the merchant network acceptance 15073. The institution is not required to enter a value for every field in the process; yet, the more fields that are included, the greater the robustness of the results. The second rule is the source of the data on which the PPLI bases its determination, which is the Transaction Details and History memory 1211.

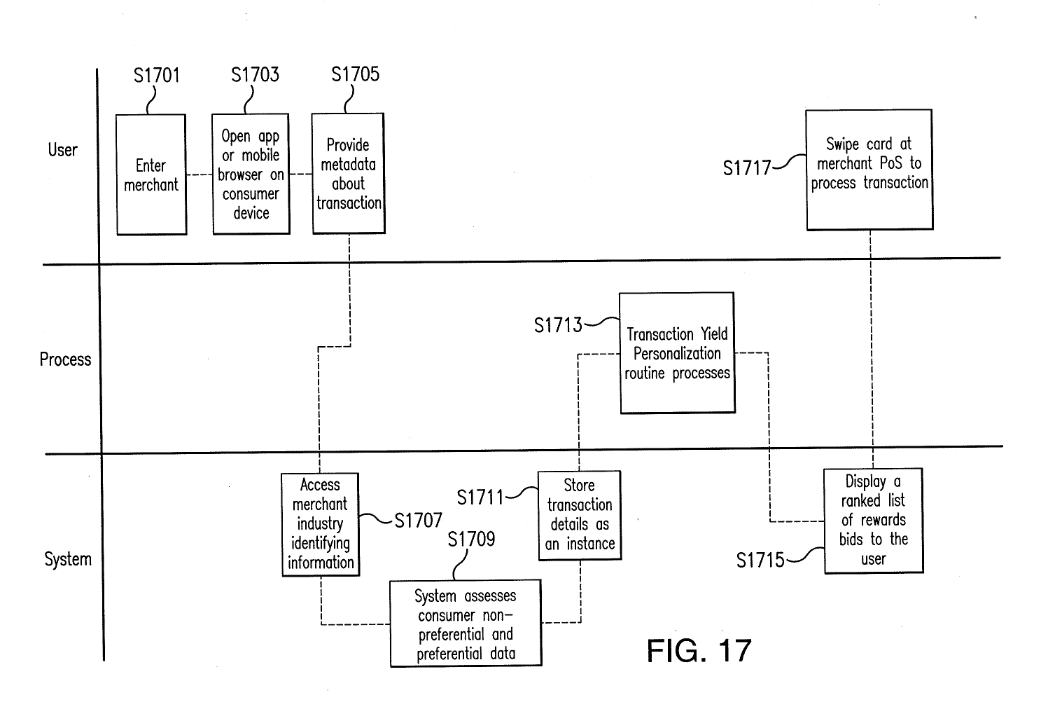

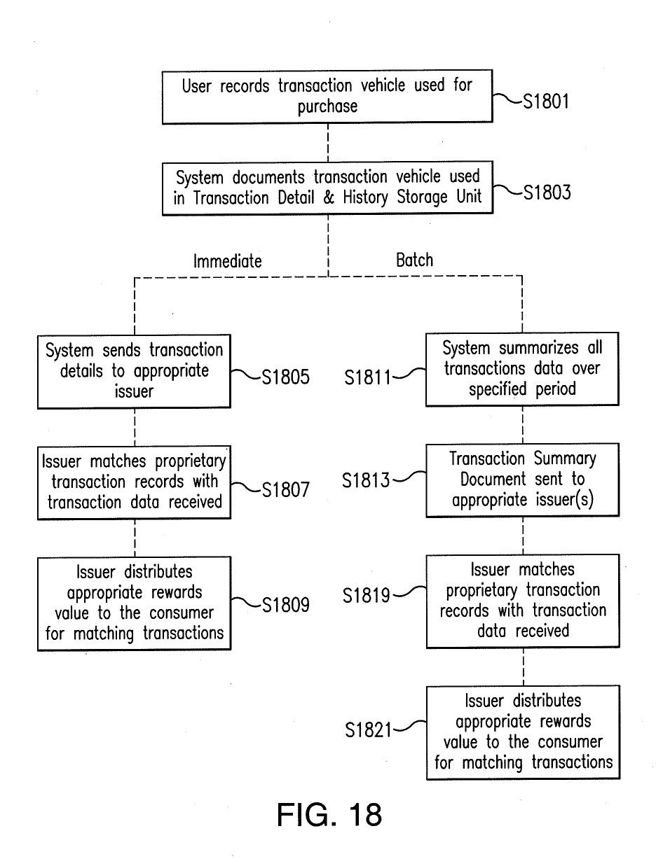

Thus, the issuer has the ability to deeply customize the processed fields by choosing specific inputs, and the PPLI follows by accessing stored data that are collected from transactions in which users have input, and computer code has stored, data in the processes described in FIGS. 17-18.

There are four main components to the PPLI: 1) Determination of Transaction Details S1501, 2) Determination of User Non-Preferential Data S1503, 3) Determination of User Preferential Data S1505, and 4) Determination of Conversion Constraints S1507. The method and system requires the input of data in each of the four components by one party, the reward-issuing institution. Considering the purpose of the present invention, to allow an institution to test and better understand how to make a prudent rewards bid, it is necessary that one institution be able to test any combination of specific conditions in any combination it determines valuable. Thus, using PPLI, a single issuer can input specific values for each of the component pieces, and as an output, understand a percentage likelihood of the conversion on that issuer's transaction vehicle under the specified conditions.

The first component, determination of Transaction Details is made up of four data inputs: 1) Transaction Amount 15011, 2) the Purchase Item Categories in the transaction basket 15013, 3) the Merchant Information 15015, and 4) the Rewards Bid Amount 15017. The first input, the transaction amount 15011, is the same as is defined in-FIG. 2, the total bill one would need to pay at a merchant to complete a transaction. Yet, in contrast from the description of S201 in FIG. 2, the collection of this data will be input by the rewards issuer. If no amount is input, the present invention has the ability to assume a standard transaction value, so as to reduce the user interaction burden required to key in a transaction value.

The second data input is the purchase item categories in transaction basket 15013, which are the types of items that the consumer will be purchasing during the transaction. The PPLI allows the issuer to specify a category of merchandise. Similar to a Merchant Category Code, the Rewards Bid Portal provides issuers with an extensive selection of categories, such as Electronics, Organic Groceries, or Winter Clothing, that the issuer can select in order to further personalize a rewards bid. For example, a small local bank may want to understand the value of a rewards offer that a consumer expects when purchasing electronics; the bank could specify this in their inputs to the PPLI, which then returns the appropriate purchase likelihood determination. A similar list will be provided to the consumer when he/she enters a merchant in step S1703, described in FIG. 17, allowing the system to have a closed loop of data.

The third data input of the transaction details is the Merchant Information 15015, which allows an issuer to input a specific merchant whose consumers they want to target. Thus, rather than depend on Merchant Industry Identifying Information, as in S2033, the PPLI allows the issuer the ability to specify an exact merchant, such as Target Co. or ExxonMobil. The last component of the transaction details is the Rewards Bid Amount 15017, which is defined as the amount, in any type of rewards currency or currencies, an issuer offers to a consumer. Again, this variable will be collected from the issuer when the process is run. This variable is relevant to the process-because it provides the independent variable on which the dependent variable, a consumer's transaction vehicle choice on a particular transaction, varies most. In other words, the invention assumes that purchase likelihood by a consumer depends most upon the rewards yield that a consumer can gain from that purchase, and therefore, the PPLI allows the issuer to vary this input at will in order to test how a consumer is predicted to respond to varying rewards offers. The analysis conducted by the PPLI utilizes data about the competing rewards bids being offered by other issuers; thus, the variable 15017 is both an input field provided to the issuer and also a variable present in the determination that contains potential bids from other issuers. In the case that no other issuer has directly input a bid, the present invention has the ability to consider bids that have not been entered directly through the Rewards Bid Portal as described in FIG. 12, but rather the transaction yields contained in the Transaction Vehicle Account Program Details (S2031) memory as described in FIG. 2.

The second component of the PPLI, determination of User Non-Preferential Data S1503, is another field of the process or module of the system that will be input directly and enable further personalization by the issuer. By definition, a user attribute is defined as the plurality of data fields that can be assigned to any user that is not inclusive of their preferences. Examples include demographic data 15031, such as age, gender, wealth; location-based data such as city and zip code 15033; and others, such as a user's social influence and outreach strength, calculated by companies such as Klout or Kred 15035. The algorithm allows merchants to enter values for these fields in order to further predict what a prudent personalized rewards bid would be.

Determination of User Preferential Data S1505 is the third component of the PPLI. By definition, preferential data is defined as the universe of explicit S15051 and implicit S15053 preferences that could be collected about a consumer. For example, explicit categories 15053 include such preferences as type of rewards currency as well as favorite brands, hobbies, travel destinations, or foods. Implicit categories 15051 are preferences that the present invention identifies via machine learning and mining of trends in such data as purchase or visit histories; for example, if a specific consumer has visited ten pizza restaurants and zero sushi restaurants, the system may assume that such a user prefers pizza to sushi. The explicit and implicit preference fields of the PPLI are input by the issuer, such that they can specify the type of user preferences they would like to target and better understand the purchase tendencies of those consumers.

The last component of the PPLI is determination of Conversion Constraints S1507. Conversion constraints are defined to include any potential limiting condition that may affect the conversion of a transaction. Examples of such conditions could be the credit utilization 15071 of a customer, such that a customer has maxed out their line of credit with a specific issuer, or is approaching that limit. This field is input by the issuer; for example, if an issuer wants to attract more transactions from consumers close to their credit limit on other cards, they could use this field to understand what the appropriate bid to do so would be. Another example is merchant network acceptance 15073, such that a specific merchant does not accept cards issued by Visa or American Express, and thus a conversion with a card of such type would be impossible. The data of Merchant Network Acceptance is referenced by the system, rather than input by the issuer. Thus, if the system is aware that a specific store does not accept Visa, the process will return a null value for the purchase likelihood.

While the issuer has the ability to personalize each of the fields of the PPLI to understand how to better target and attract specific consumers, no identifying consumer data is accessible to the issuer at any time. Thus, the issuer is able to target users in an extremely sophisticated manner without ever knowing who the specific individual is. This measure is enacted for the protection of the consumer and their continued trust in the provider of the invention. In the same manner, any issuer utilizing the PPLI method does not have the ability to view the recorded bids of any other issuer. Rather than display such bids, the PPLI will display the number of conversions for the potential bid as well as the forecast number of total conversions; this allows for the determination of the share of conversions an issuer will receive for a specific customer conducting a specific transaction using simple division.

An example is useful to describe the situation in which the PPLI would be utilized, and the output-it would present. In this case, for example, assume Chase Bank would like to know the most prudent rewards bid to get consumers living in New York City over the age of 50 at restaurants to choose a Chase Sapphire Card. In such a case, a representative from Chase Bank signs into the RBMP, accesses the PPLI, and specifies the exact aforementioned conditions, as well as a-potential rewards bid, and a period of time. As an output, the PPLI displays the total number of times that the null hypothesis, that a consumer will choose a Chase Sapphire card if they were to be offered the bid being tested, is not rejected. It also displays the total number of events tested. In other words, the PPLI predicts how many times that the specified consumer would be in the specified situation under the specified time period. This total conversions value displays to the issuer its hypothetical share of wallet by segment by purchase type. An example of this output is as follows: the Chase Sapphire Card is predicted to receive five and a half million transactions if they bid 2.5% cash back at restaurants out of the twenty five million transactions that over 50 consumers are forecast to undertake at restaurants from the period of January to March 2012. Now, if Chase were to find such a result attractive, they may directly input a rewards bid, as described in S1309, of 2.5% cash back at restaurants for consumers over 50 for the time period January to March 2012. This bid would be stored in the Reward Bid Storage Unit as described in S1311, and presented to qualifying consumers as described in FIG. 17 if the specified conditions are met.

In summary, an issuer has the ability to sign onto the RBMP and utilize the PPLI; notably, the issuer has the ability to input a series of different values for the Rewards Bid Amount and understand the effect those values have on the Personalized Conversion Process. In this way, the PPLI will serve as an unbiased advisor to the various issuers on what a prudent rewards offer may be to target a specific segment of consumers in a specific situation.

FIG. 16 represents the system and process called Reward Bid Recommendation Engine (RBRE), by which two types of recommendations are provided: 1) new rewards bid recommendations S1601, and 2) existing bid improvement recommendations S1603. The first, new rewards bid recommendations, is made up of two main components: 1) determination of high-opportunity user segments 16011, and 2) determination of bid win scenarios 16013. The second, existing bid improvement recommendations, is made up of one component: 1) Determination of bid loss scenarios 16031. The RBRE is accessed via the Rewards Bid Management Portal and is utilized when an issuer solicits recommendations from the RBM. Similar to the PPLI, the RBRE utilizes data collected from transactions and stored in the Transaction Details and History memory 1211.

The first component of new reward recommendations is determination of high-opportunity user segments, which is made up of three data inputs: 1) segment bid penetration 160111, 2) segment bid amount 160113, and 3) expected segment value 160115. The first input, segment bid penetration 160111, is a value that represents the relative number of bids have been targeted at a specific segment. This amount is generated by an automated query whose parameters are set based on the segment being analyzed. The query is carried out by a system of computer software and hardware, and the query can be executed at any time such that it reviews and summarizes the RBM's contents instantly. The amount can be input as either a number or percentage. For example, the query can report that twenty bids have been input specifically targeting consumers of the ages 30-35 that live in zip codes with average household incomes above $200,000. Alternatively, the query can report that twenty percent of all issuers on the system have input a bid targeted at these same consumers.

The second input to determine high-opportunity user segments is segment bid value 160113, which is a summarized amount of the average bid being offered to a specified segment. This amount is again generated by an automated query within the RBM whose parameters are determined based on the segment being analyzed. Again, the query is carried out based on a system of computer hardware and software that can be executed at any time. In this case, the query reports, for example, that the average bid for males aged 22-25 at a grocery store with less than 3 credit cards is 2.5% cash back.

Expected segment value 160115 is the last data input required to calculate high-opportunity user segments, and utilizes the process called Segment Expected Value (SEV). The SEV determines the average potential lifetime value that a specified customer segment is worth to a reward-issuing institution. The process is made up of a plurality of inputs about a segment that have some bearing on that segment's current and future economic value. Examples of data that could be included are annual average spend amounts, a segment's typical bill pay practices, the average age of the consumers in that segment, average salary, or social media influence, among others. These data are collected and stored in the Consumer Preference and Demographic Storage Unit 1213 and are used to calculate a forecasted lifetime value for each consumer. For example, the segment of consumers that are of ages 28-35, live in an urban setting, and work in financial services may have a forecasted lifetime value of $4,500, whereas post-60 year old consumers who have retired may have a forecasted value of $1,000.

The RBRE can compare average expected lifetime value to the amount invested by rewards issuers in that segment, a result of the number and average value of bids targeted at that segment, to identify segments that are being under-valued. The discrepancy between expected value and amount invested creates a high-opportunity index. For example, a segment with an expected lifetime value of $1,000 with an investment of only $500 would be tagged as a high-opportunity segment; the greater the discrepancy between lifetime value and investment, the greater the opportunity. These under-valued segments are reported to issuers as recommendations by the RBRE when they enter the Rewards Bid Management Portal and solicit a recommendation (S1313).

The second component of a new bid recommendation is determination of bid win scenarios. This component is an added layer to the determination of high value that provides issuers with recommendations based on previously successful bids entered in the system. Bid wins are defined as instances in which the bid offered to a consumer is chosen for a given transaction. Such scenarios are captured by the present invention whenever a user is shown a plurality of bids and makes a selection of which bid to accept—the accepted bid, as well as the other bids presented and not chosen, are recorded by the system as described in step S1803. With a collection of millions of transactions and the winning bid selected in each, the RBRE is able to determine trends of which types of bids are successful with certain types of consumers. Thus, if an issuer solicits a recommendation for a specified user segment as described in step S1313, the RBRE is able to present a summarized set of strategies that have succeeded in winning transactions from this segment in the past. To bring back a previous example, imagine Chase would like to target young men aged 22-25 that have less than 3 cards, yet, Chase does not have a specific bid in mind that they would like to offer this segment. They solicit the RBRE with such specifications and are then presented with a summarized list of previously successful bids for this segment, for example, that when Discover offered 2.85% cash back for electronic purchases, it won 92% of bids on such transactions.

With these two inputs, high-opportunity user segments 16011 and bid win scenarios-16013, the RBRE is able to make very specific recommendations to issuers looking to create new bids. These recommendations are based on facts collected from historical data, as well as forecasts informed by previous actions. In addition to the proprietary system and method described herein for discovery of under-valued segments and presentment of recommendations, the present invention also includes the creation of an application programming interface (API) that allows for the design and creation of different methods by users of the RBM. This API would allow such users to call the anonymized data of the RBM in a method or system designed by them. For example, imagine an issuing bank that uses the system has uncovered a unique set of ingredients that effectively discovers new segments; in such a case, the issuer can access the aforementioned API in order to call the RBM and access its stored data.

Now take the scenario when an issuer has observed or been informed that an existing bid has received very few bid wins. Utilizing the RBRE, that issuer can uncover recommendations for improvement S1603. This is the second component of the RBRE, and is made up of one component, bid loss scenarios 16031. A bid loss, by definition, is the exact opposite of a bid win: it is a losing bid offered to consumers for any transaction. Thus, every transaction has one bid win, and multiple bid losses. Again, the RBRE accesses this information from the Transaction Details and History Memory 1213 as it is recorded by the system as described in step S1803. In order to provide improvement recommendations on existing bids, the RBRE summarizes bid loss scenarios to provide issuers potential strategies to improve. For example, an issuer can solicit the RBRE for a recommendation for improvement, as described in step S1411, and is shown that a specific bid has lost to a bid of the exact same rewards discount but with greater ulterior benefits. For example, a 2.5% cash back bid offered by Chase has been a consistently losing bid because CitiBank has offered 2.5% cash back as well as extended warranty for the specified transaction and customer segment. Thus, the outputted information provides bid improvement strategies for the issuer.

FIG. 17 illustrates the portions of the system 700 for arbitrating and presenting a rewards bid to a consumer, called Rewards Bid Arbitration and Presentment. Rewards bids that have been created by the aforementioned process described in FIG. 13, and informed by the PPLI and RBRE via the output of the processes described in FIG. 15 and FIG. 16, respectively, sit dormant in the Rewards Bid Memory 1209 until a consumer triggers that bid by accessing the system and meeting a specific set of criterion. Again, in this embodiment this Reward Bid Memory 1209 that is part of the Reward Bid Manager, will replace the Transaction Vehicle Reward Program Memory 809 referred to in FIG. 8. A trigger occurs when a user enters a merchant in step S1701. In step S1703, the consumer opens a mobile application or web browser or some other equivalent platform. Next, the user inputs a plurality of data about the transaction they are about to conduct, such as the merchant they are at and the transaction amount of the goods they are purchasing in step S1705. Other data could also be included, such as the item types as described in FIG. 15. In addition to the real-time information entered by the user in steps S1701 through S1705, the system accesses the Merchant Name Information and Merchant Industry Identifying Information of the merchant specified by the consumer in step S1707. The user's non-preferential data such as their age, gender, or other descriptive pieces of information are accessed by the system in step S1709, in the same method as described in S307. The system will store the detail of the transaction and consumer conducting the transaction in step S1711 to the greatest level of details possible in the Transaction Details and History Memory-1213. Following the collection of the plurality of data from both the consumer and proprietary sources, three further steps must be taken prior to presenting reward bids to the consumer.

Step S1713 is when the system utilizes a process called the Transaction Yield Personalization in order to calculate the personalized yield of each rewards bid. The Transaction Yield Personalization routine (TYP) is described in detail in FIG. 2. To demonstrate how the process applies to the present embodiment, it is instructive to understand what has changed from the previous embodiments-depicted in FIG. 2 and FIG. 5. Under these previous embodiments, web spiders were used to collect the rewards program information as conceived and distributed by the reward-issuing institutions, and stored within the Transaction Vehicle Rewards Program Memory S809. Under the present embodiment, rewards bids are entered into the Rewards Bid Memory 1209 via the online Rewards Bid Management Portal. Yet, the rewards bids within the Rewards Bid Memory and the Transaction Vehicle Rewards Program Memory S809 will be of the same nature; in other words, both Memory areas will contain rewards offers that are some combination of cash back, or other point currency, and potential ulterior benefits, such as extended warranty or purchase protection. As such, having executed steps S1701 to S1711, and combining this with the bids stored in the Rewards Bid Memory, the TYP will have the required data inputs to calculate a personalized transaction yield in the same manner as FIG. 2.

After the TYP has determined the personalized yield of the plurality of bids, the system serves the plurality of bids in a ranked manner to the consumer in step S1715, as depicted in FIG. 10. Following presentment of reward bids to the consumer, the consumer closes the transaction by swiping his/her card at the merchant POS in step S1717.

Once the transaction is completed, the reconciliation process begins. FIG. 18 describes a system called Reward Bid Reconciliation (RBR) for the case in which only static transactions are-enabled; by definition, a case when the consumer must pull his/her card or card equivalent to conduct a transaction. In such a situation, reconciliation begins in step S1801 in which the consumer records the transaction vehicle used for the purchase by selecting the transaction vehicle that he/she has chosen via a tap on a phone screen or other consumer device. The RBR documents the payment vehicle chosen information as an additional field in the Transaction Details and History Memory in step S1803. The Transaction Details & History Memory has already logged information about the transaction such as the merchant, approximate amount of the purchase as specified by the consumer, and the corresponding rewards bid; after step S1803, the memory will also include a field for the card or other instrument that was chosen to conduct the transaction. Rather than send every transaction to the issuing bank for reconciliation as it occurs, the RBR batches transactions on a statement period basis, just as issuers do today. On the end date of each statement period, the RBR sends the full log of transaction-specific information to the appropriate issuer in step S1805. The RBR also provides the consumer with a full report on their transactions over the period as well as the corresponding rewards in step S1805. The transaction Summary Details contain the name of the consumer, the merchants at which he/she transacted with that issuer's transaction vehicle, the amount of the transaction, and the reward bid displayed to the consumer. In step S1807, the issuer is able to match their records with the Transaction Summary Details they receive from the RBR on a per-transaction basis. For transactions in which there is a match, the issuer is then responsible for distributing the appropriate amount of rewards that have accrued over the period for matched transactions in step S1809, pending any additional rules they have input on such distribution. One such additional rule may be that a consumer must pay their bill on time. The issuer is only liable for transactions that match with the issuer's internal transaction history data. If there is a case in which the Transaction History Details from the present embodiment do not match with the Data from the issuer, the issuer's data set is taken as the master data set, and the issuer is not-liable for distributing the rewards promised for the transaction in question. This completes the per-transaction reconciliation process.

Having explained the individual pieces of the present invention, an end-to-end example is useful to clarify how the invention is used. To continue an example referenced previously, a young male aged 22-25 with less than three credit cards is targeted by an issuer. Discover, having recognized this segment as being relevant for the growth of its business, has signed into the Rewards Bid Management Portal (1203) and solicited advice via the RBRE (1207) on what would be a prudent rewards bid to offer this targeted consumer to potentially win his business on their “Free” card. Given the information at its disposal, the RBRE is able to scan bid win scenarios for the specific segment, and also strategic areas the segment is being undervalued. Say, for example, that the RBRE recognizes based on segment bid penetration and bid amounts, the segment is actually being undervalued in their transactions at the Dry Cleaner. Given that information, and that no other provider has offered any reward bid over 1%, Discover may find that in order to win a majority of the transactions from this segment, an ideal bid to catch the attention of these consumers would be 5% cash back and an offer of purchase protection, in case anything is damaged. Discover, given their willingness to strategically invest to win business in this segment, decides it will provide-the reward and purchase protection for males between the ages of 22-25, and enters this bid into the Rewards Bid Management Portal for the period of May-September 2012. This bid is then saved in the Rewards Bid Memory.

Now, to the example of the young male entering a dry cleaner to drop off a few items. Aware of the value provided by the present invention, he opens his mobile phone to the application he downloaded, and logs his location as his local dry cleaner. He likes having a summary of his purchases, so he also enters that he is dropping off ten shirts and two suits, likely spending around $80. Utilizing this information, as well as the information he has previously stored about his age, the system utilizes the Transaction Yield Personalization (TYP), and delivers his set of personalized recommendations that have been adjusted based on preferences he has logged. Seeing that he has the opportunity to gain greater rewards for the next few months on his dry cleaning visits by using the Discover Free card, he applies for the card seamlessly through the application as described in S325. Given he is pre-approved for the card, he receives a message that a card has been sent to the address he has stored in his profile. Assume he now enters the same dry cleaner the following week and now has the Discover Free card in his wallet. He checks into the mobile app, and registers a similar purchase, $80 at the dry cleaner, and sees the same 5% cash back offer from Discover. This time, he pulls out his Discover at the register to complete the purchase, and records that he has done so on the application. The transaction is now complete.

At the end of any defined period, the system will generate a report that logs one transaction at a dry cleaner for $80 using a Discover Free card. This report is sent to Discover for reconciliation. Discover will then reconcile this report with their records; they see a transaction on the same date at a dry cleaner for $77.50. Taking their records as the master, and understanding that the user-input data is approximate, they award a 5% cash back reward to the consumer on the $77.50 after he pays his bill on time. As described previously, if the situation arises in which the consumer did not log the transaction within the application, Discover would not be liable by utilizing the present invention to deliver the 5% cash back reward, although they may do so anyway as they are able to reconcile the transaction using their internal reconciliation process.

In the description of the system called the Rewards Bid Manager (RBM) depicted in FIG. 12, the method called the Personalized Purchase Likelihood Index described in FIG. 15, the method called the Rewards Bid Recommendation Engine described in FIG. 16, and the system called Rewards Arbitration and Presentment described in FIG. 17, one assumption held throughout is that the rewards issuer manages the process and simply interacts via personal computer devices with the system, method, and entities that own or license the invention. This, however, is only one representation of how the methods and systems function. Another situation that the present invention covers is one in which an issuer elects to have the owner or licensing entity of the invention manage this process. In such a case, the owner or licensee assumes control of the rewards bids assigned to the aforementioned rewards issuer in the system. These bids are, for example, informed by a joint meeting in which the owner or licensee and the rewards issuing entity mutually agree on a set of strategic goals and outcomes. An example of this situation is as follows: KeyBank, a small regional bank, would like to expand into new regions and customer segments, specifically over-50 year olds in the Northeast. To do so, KeyBank arranges a meeting with the owner or licensee of this invention and explicitly state such a goal, and the expected performance measures they aim to achieve. The terms of such a goal are then written into a statement of work that indicates the powers of the owner or licensee to manage the KeyBank's reward program for the specified customer segment in the specified region. Moreover, KeyBank stipulates further rules and terms to which the owner or licensee is held, for example, no bids greater than a certain amount will be made, and no strategic partnerships could be entered with brands that may damage the public image of KeyBank. Once an agreement between KeyBank and the owner or licensee has been met, the owner or licensee is assigned the responsibility to manage and execute the rewards bid strategy for KeyBank for the duration of the contract. In such a situation, the owner or licensee then leverages the systems and methods described herein, specifically the PPLI in FIG. 15, and RBRE in step FIG. 16, to inform potential bids that can achieve the goals and outcomes upon which the parties agreed. The owner or licensee then inputs the bids, as described in steps S1309 and S1319.

One scenario to discuss is a case in which the owner or licensee of the invention is hired by two or more issuers to manage their rewards bids for the same segment and set of conditions. For example, Issuer A and Issuer B have both signed contracts allowing the owner of licensee of the present invention to manage their rewards bids for female consumers between the ages of 30-35 shopping for athletic gear. In such cases, it is clear that the owner or licensee is managing potentially conflicting interests. In order to overcome such conflicts, contractual terms and conditions are provided to each issuer such that each situation is approached in a simple and uniform way.

### D. Real-Time Auctions for Personalized Reward Bids During Dynamic Transactions

The present embodiment describes the set of systems and methods involved in creating and presenting personalized rewards bids to consumers in a dynamic transaction. By definition, a dynamic transaction is one in which mobile checkout is enabled. To repeat the definition laid out in the previous embodiment, mobile checkout is a situation in which the consumer does not need to remove a card from his/her wallet, but can simply tap a button on his/her phone to confirm a transaction, or put his/her phone within some distance of a receiver that reads the card information securely via remote communication technology, such as Near Field Communication (NFC) chips. Thus, in contrast to the previous embodiment, Real-Time Auctions for Personalized Rewards Bid with Static Processing, the present embodiment will describe the set of systems and methods used to achieve the same result in a situation with mobile checkout. Again, prior art exists with regard to dynamic transaction processing systems, such as patent US2011/0078081 A1 issued to Pirzadeh and Kekicheff. Embodiments herein related to dynamic transactions build upon this prior art with novel features.

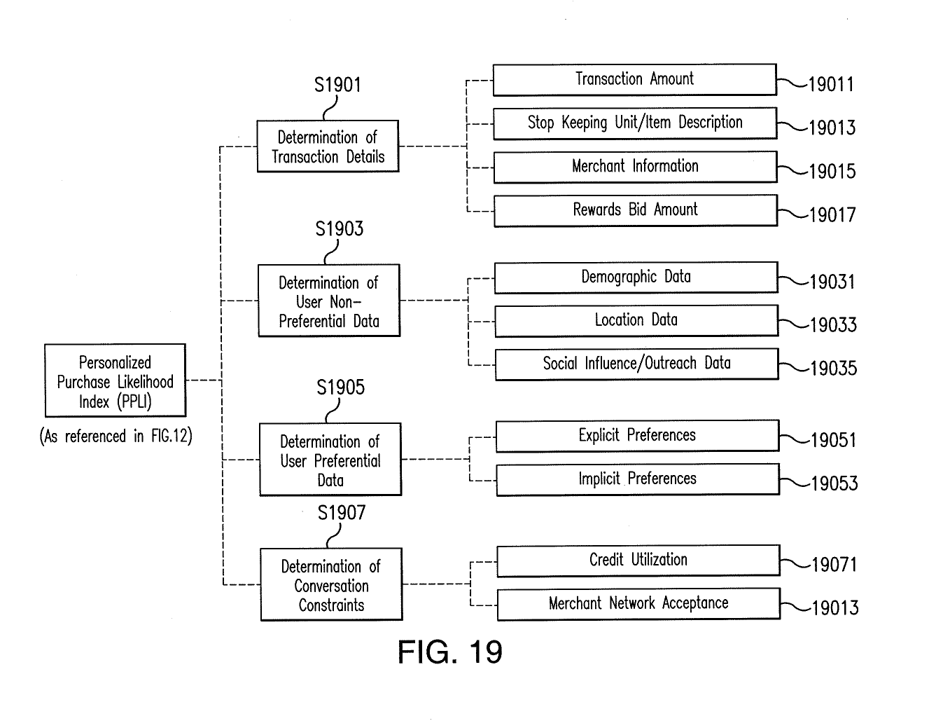

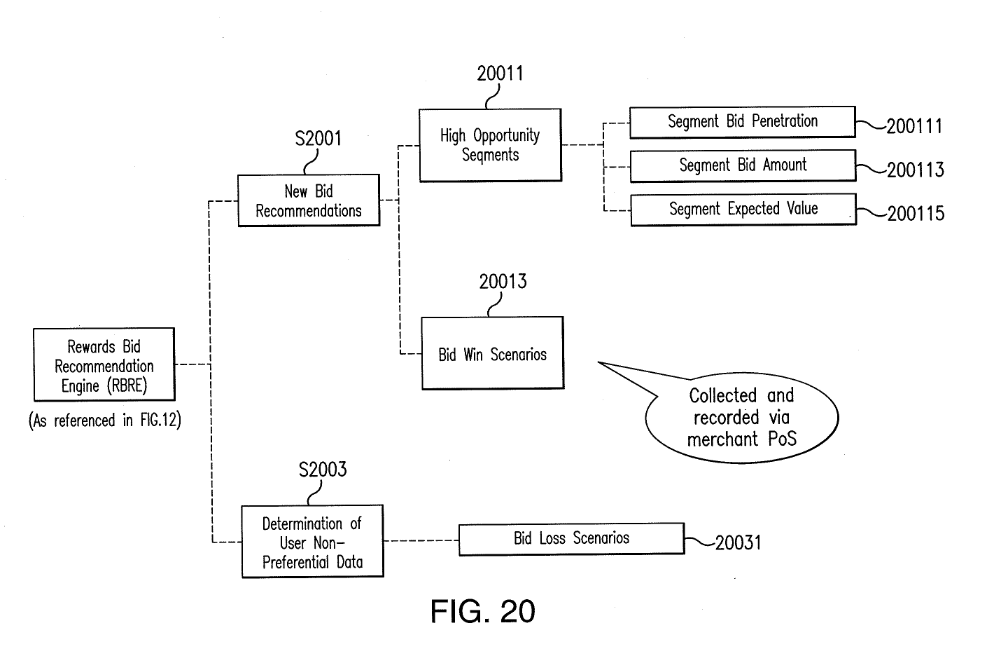

The RBM remains a significant system in the present embodiment and it retains the same architecture of the Rewards Bid Management Portal (RBMP) and multiple methods that access a set of supporting memories. Therefore, FIGS. 11-12 remain an applicable architecture for this embodiment. The RBMP continues as the front-end portal for reward bid creation and change requests. Due to changes in the manner in which data is collected in a dynamic transaction, as well as the granularity and fidelity of the data, some slight variations have occurred in the variables utilized in the determination of the PPLI and RBRE, which will be described in FIG. 19 and FIG. 20 respectively. Yet, regardless of slight variations to the data involved in calculations in steps S1305, S1315 and S1413, the intent and system depicted in the steps of FIG. 13 and FIG. 14 are no different for a transaction involving mobile checkout. Thus, the present embodiment still allows issuers to sign into the RBMP S1301, create S1303 or solicit RBRE recommendations for S1313 a new reward bid, and go through the necessary steps to activate these rewards bids by inputting them into the Rewards Bid Memory S1305 to S1311 and S1315 to S1321. Similarly, the present embodiment also allows issuers to sign into the RBMP S1401, access a previously entered bid S1403, create S1405 or solicit RBRE recommendations for S1411 a change to an existing reward bid, and go through the necessary steps to activate edited rewards bids by inputting them into the Rewards Bid Memory S1407 to S1409 and S1413 to S1417.

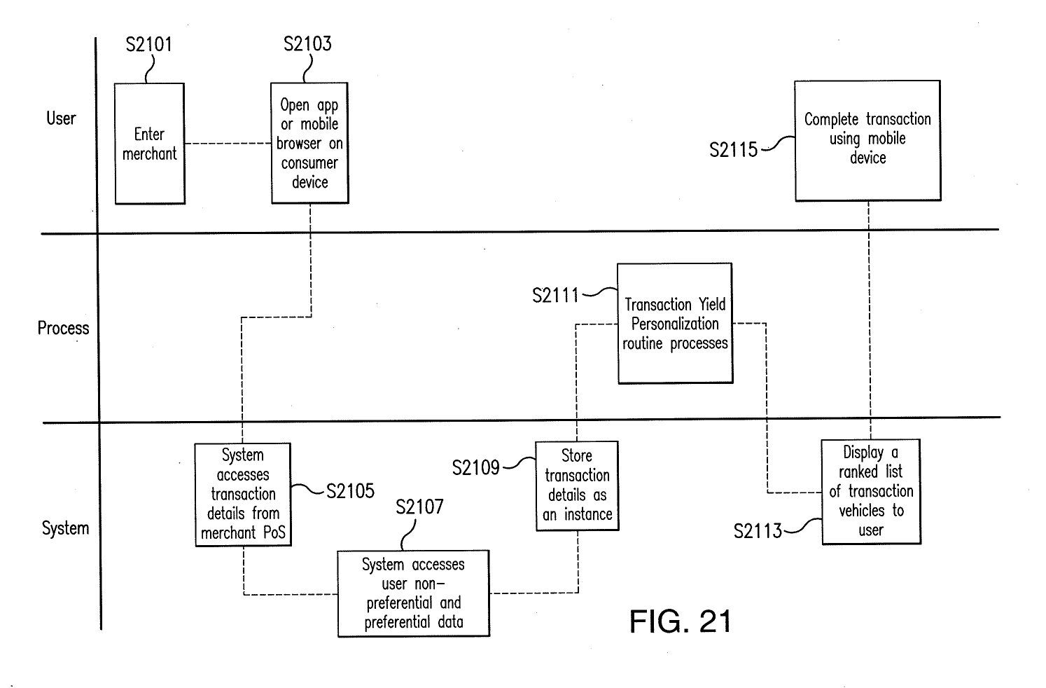

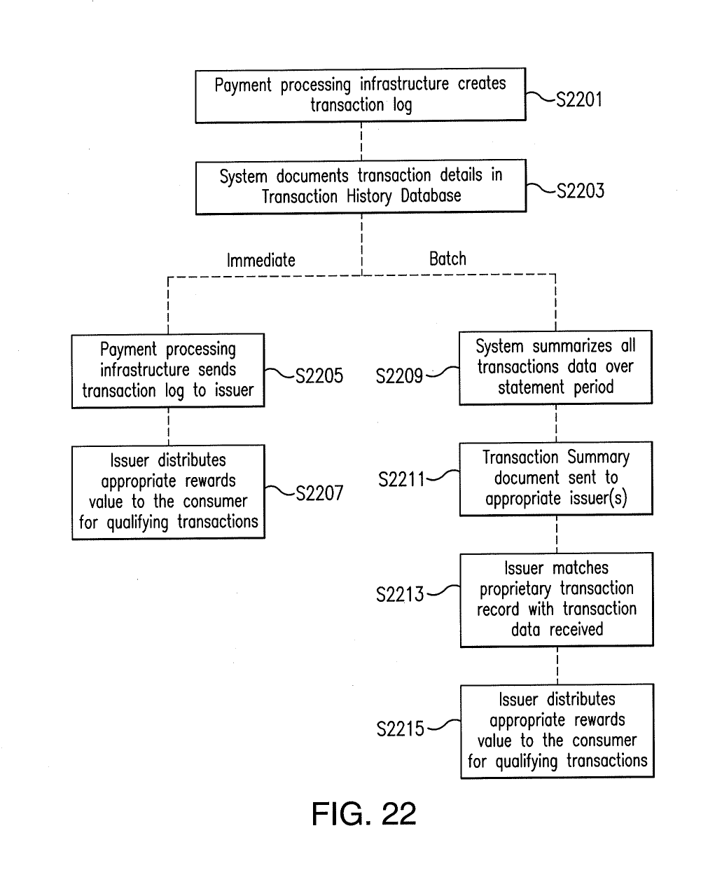

FIG. 19 represents the method called the Personalized Purchase Likelihood Index (PPLI). As previously stated in FIG. 14, the PPLI is a customizable process or module that allows issuers to choose the fields included and accesses data collected and stored by the Arbitration and Presentment (FIG. 21) and Reconciliation (FIG. 22) systems. In the present embodiment, there remain four main components to the PPLI: 1) Determination of Transaction Details S1901, 2) Determination of User Non-Preferential Data S1903, 3) Determination of User Preferential Data S1905, and 4) Determination of Conversion Constraints S1907. However, the PPLI also undergoes two slight changes: 1) how the data it accesses are collected, and the quantity and accuracy of this data, and 2) the usage of Stock Keeping Units (SKUs) rather than Purchase Item Categories.

To address the first change, the PPLI will no longer depend on user-input data for its analysis. Thus, information such as the merchant location or amount of transaction is no longer keyed in by a user. In the present embodiment, data is recorded directly via the merchant POS, as described in FIG. 21 in step S2105 and FIG. 22 in step S2203. As a result, the PPLI is more robust and accurate due to the greater quantity and accuracy of the data collected. It is expected that directly recorded data, only available via a secure link to the merchant POS, is superior in quantity and accuracy to the previous embodiment because it is assumed that some users do not record their transaction details for each and every purchase, and that the accuracy of the data when they are input is not guaranteed.

The second change arises from a newly introduced variable in substitution of a variable in the previous embodiment. That new variable is called Stock Keeping Units 19013, and it will replace the previous variable called Purchase Item Categories 15013. In a dynamic transaction, SKU data is recorded by interacting with the merchant POS; these data can then be stored in the Transaction Details & History Storage 1213. In addition to obtaining the data from the PoS, the Transaction Details & History Memory can interact dynamically with the retailers supply and inventory systems, such as SAP. Thus, rather than simply relying on purchase item categories 15013, the PPLI can access more granular data on the exact items being purchased.

The availability of more granular data delivers issuers the ability to test and understand purchase likelihood with more specificity by allowing them to test at an item-by-item level. This specificity is valuable to issuers as it can better inform their potential rewards bids.

FIG. 20 describes the method and device called the Reward Bid Recommendation Engine. As described in FIG. 16, the RBRE is able to provide recommendations to-issuers in the case that it would like to create a new bid, or improve an existing bid. The sole difference between FIG. 20 and FIG. 16 is how the data utilized by the RBRE is collected, and how this new collection mechanism provides data in greater quantity and with greater accuracy. Again, the RBRE provides recommendations of two types: 1) new rewards bid recommendations S2001, and 2) existing bid improvement recommendations S2003. The first type, new rewards bid recommendations, is made up of two main components: 1) determination of high-opportunity user segments 20011, and 2) determination of bid win scenarios 20013. The second type, existing bid improvement recommendations, is made up of one component: 1) determination of bid loss scenarios 20031. For the purposes of describing FIG. 20, assume that all functions, variables, and methods are the exact same as FIG. 16, unless specifically described below.

As previously stated, the sole difference surfaces in the collection of data, specifically, data related to determination of bid win scenarios 20013 and bid loss scenarios 20031. In the previous embodiment, the RBRE creates insights for new bid reward recommendations and existing bid improvement recommendations by taking in all the rewards bids offered to a consumer for a specific transaction, understanding which bid was selected, and returning patterns or insights based on whether a bid is won or lost. The previous embodiment collected this data via a user inputting the information on their mobile device after the completion of a transaction. In the case of a dynamic transaction, however, this data will not be input by a user but rather recorded directly via the merchant POS at the moment a transaction is completed. By utilizing data collected directly via the merchant POS, the RBRE is able to base its determination on a greater quantity of data that is more accurate; as a result, its recommendations are of greater robustness. Again, data collected direct via the merchant POS is superior in quantity and accuracy to the previous embodiment because it is assumed that some consumers do not record their transaction vehicle used for every purchase, and that the accuracy of the data when they are recorded is not guaranteed.

FIG. 21 is a representation of a system of Rewards Bid Arbitration and Presentment in a dynamic transaction, a more substantially affected process during a dynamic transaction. As described in FIG. 17, rewards bids that have been created via the RBMP and informed by the PPLI and RBRE sit dormant in the Rewards Bid Storage Unit until a consumer triggers that bid by meeting a specific set of criterion. Such an event occurs when a user enters a merchant in step S2101. In step S2103, the consumer opens a mobile application or web browser on a mobile consumer device. In contrast to the flow described in FIG. 17, the requirements to input a merchant location or transaction amount no longer exist since this information is automatically recorded at the time of purchase in a dynamic transaction. As such, in step S2105, the system accesses a plurality of data via the merchant POS, including transaction details such as the merchant at which the transaction is taking place, the amount of the purchase, the stock keeping units and descriptions of items, quantity of items, and others. In addition to the real-time information collected by the system via the merchant POS in step S2105, the system accesses non-preferential and preferential data about the user making the purchase, such as their age, gender, or other descriptive pieces of information in step S2107, in the same method as described in S307. The system will store the details of the transaction and consumer conducting the transaction at the greatest level of detail possible in step S2109 in the Transaction Details & History Memory. Following the collection of the plurality of data from both the merchant POS and proprietary memories, one more step must be taken prior to presenting reward bids to the consumer.

Step S2111 is when the system utilizes a method called the Transaction Yield Personalization routine in order to calculate the personalized yield of each rewards bid. The present embodiment utilizes the same process as is described in FIG. 13 to enter rewards bids-into the Rewards Bid Storage Unit via the online RBMP. These bids will be of the same nature as those in the Transaction Vehicle Rewards Program Storage Unit S809. As such, both memories-contain rewards offers that are some combination of cash back, or other point currency, and potential ulterior benefits, such as extended warranty or purchase protection. Therefore, having executed steps S2101 to S2109, and combining this with the bids stored in the Rewards Bid Memory, the TYP has the required data inputs to process a personalized transaction yield across multiple reward bids.

After the TYP has processed the personalized yield of the plurality of bids, the system will serve the plurality of bids in a ranked manner to the consumer in step S2113, as depicted in FIG. 10. Following presentment of reward bids to the consumer, he/she completes the dynamic transaction in step S2115 by, for example, tapping a button on his/her mobile device or putting such a device within a specified range of some reading mechanism such as a Near-Field Communication (NFC) chip.

Once the transaction is completed, the reconciliation process begins. FIG. 22 describes a system called Reward Bid Reconciliation (RBR) for the case in which mobile transactions are enabled. In contrast to FIG. 18, reconciliation is far simpler in a dynamic transaction, and begins in step S2201, when the existing payment-processing infrastructure creates a transaction log. A transaction log is a summary of the plurality of data fields collected during a transaction, such as the time of transaction, amount, items purchased, and others. This log is sent with the completion of every transaction from the payment processor to the payment network and finally on to the issuer. For example, upon purchasing a set of groceries at the market, the merchant POS communicates the amount, and potentially other fields, to a merchant acquirer like FirstData. FirstData then sends this data to a payment network such as Visa, who forwards the log on to the issuing bank of the card used, for example, Chase. The present invention also documents the payment vehicle utilized in the transaction as a field in the Transaction Details & History Memory in step S2203, in the same instance as the data already collected in step S2109 such as merchant or transaction amount.

The next step in reconciliation is to forward the transaction log data to the issuer, which is executed via the existing merchant payment-processing network in step S2205. In addition to the typical information such as time and amount of purchase typically sent, the transaction log also includes the rewards bid amount offered by the issuer when the consumer chose it for purchase. In contrast to a static transaction when transaction details captured by the system and those captured by the issuer may be different, dynamic reconciliation only creates one set of data. As a result, an issuer no longer requires a matching process with its proprietary transaction log data, such as that described in step S1807, in order to distribute rewards, because the bid information is included with the plurality of data they already receive and store in their records. Once an issuer receives the log data, it is then responsible for distributing the appropriate rewards amount to the consumer in step S2207, pending any additional rules it may have input on such distribution, such as on-time bill payment. Due to the fact there is a direct link with the merchant POS, there are no situations in which the transaction receipt data do not match with the data recorded by the issuer. This completes the per-transaction reconciliation process.

The RBR can also send Transaction Summary details in a batched manner, as described in FIG. 18. While a batched scenario is less likely for the present embodiment, since per-transaction logs are sent in an automated fashion, this option is still provided as a means of security and data accuracy. Additionally, the log provided to the consumer is still of value. To complete reconciliation, the RBR summarizes the complete set of transactions that were carried out by the consumer using the present embodiment over the statement period in step S2209, doing so for each issuer for which the consumer carried out a transaction. This summary includes the complete set of data in the transaction log for the entire period. A Transaction Summary Document with the complete set of data is then sent to each rewards-issuing institution for which a consumer has logged at least one transaction in step S2211. In step S2213, the issuer receives the Transaction Summary Document, and can then reconcile the Summary with its own transaction history records over the period. Again, the need for matching is no longer mandatory for the present embodiment, as the data recorded by both the issuer and RBR is identical. In step S2215, the issuer is responsible for distributing the appropriate amount of rewards that have accrued over the period, pending any additional rules they have input on such distribution, such as on-time bill payment.

Although the present invention has been described with respect to particular embodiments thereof, those skilled in the art will note various substitutions may be made to those embodiments described herein without departing from the spirit and scope of the present invention.

What is claimed is:

1. A computer implemented method of personalizing transaction vehicle rewards, comprising the steps of:
obtaining a plurality of transaction and transaction vehicle data inputs;
determining through the computer a personalized transaction yield for at least one transaction vehicle; and
transmitting for presentation through a graphical user interface an ordered list of the personalized transaction yields for at least one of the transaction vehicles.

2. The method according to claim 1, wherein the transaction vehicle is either a debit, credit, charge, prepaid card account, ACH, alternative currency, virtual currency, or person to person transfer.

3. The method according to claim 1, further comprising the step of accessing a user's consumer device in real-time.

4. The method according to claim 1, wherein the ordered list is transmitted in real-time or in arrears.

5. The method of claim 1 wherein the plurality of data inputs are obtained dynamically in real time or are stored in a computer memory.

6. The method according to claim 1, wherein the transaction yield is obtained via a point of sale system.

7. The method according to claim 3, wherein a user's physical location is determined by the computer based on global position system (GPS) technology.

8. The method according to claim 3, wherein the user's physical location is determined by the computer based on data input and confirmed by the user.

9. The method according to claim 1, wherein transaction vehicle information is obtained in real-time or refreshed periodically using web spider technology.

10. The method according to claim 1, further comprising the step of obtaining merchant category codes in real-time by cross-referencing a merchant's business name and its industry classification.

11. The method according to claim 10, wherein the industry classification code is used to determine merchant categories without translating to merchant category codes.

12. The method according to claim 10, wherein social media check-in data are used to ascertain merchant categories without translating to merchant category codes.

13. The method according to claim 1 wherein source of the inputs are user generated, bank generated and merchant generated.

14. A computer system for processing of personalized transaction vehicle rewards, comprising:
an input unit for obtaining a plurality of transaction and transaction vehicle data inputs;
a processor for determining personalized transaction yields for at least one transaction vehicle;
a transmitter for transmitting the personalized transaction yields; and
an interface for presenting an ordered list of the personalized transaction yields for at least one of the transaction vehicles.

15. The system according to claim 14, wherein the processor automatically searches and retrieves transaction vehicle yield information and determines a cash-equivalent value of various reward point programs.

16. The system according to claim 14, wherein the input unit receives preferences for different rewards currencies based on different goods being set equal to one another by changing the make up of the listing of goods.

17. The system according to claim 14 further comprising a client device which can comprise an intelligent PoS, or a remote server that stores user preferences.

18. The system according to claim 14, wherein at least one transaction vehicle is within the portfolio of a banking institution.

19. The system according to claim 14, wherein at least one transaction vehicle processed is possessed by a system user.

20. The system according to claim 14, wherein at least one transaction vehicle processed is not possessed by a system user.

21. The system according to claim 14, wherein ulterior benefits of the at least one transaction vehicle are factored into the personalized transaction yields.

22. The system according to claim 14, wherein transaction vehicle details are processed and transmitted prior to the processor receiving an indication of interest in acquiring the transaction vehicle.

23. The system according to claim 14, wherein the system automatically submits an application to a bank or merchant for a new transaction vehicle or loyalty program.

24. The system according to claim 23, wherein a message is transmitted to the processor that the card application process has been initiated by the system.

25. The system according to claim 14, wherein the processor transmits information either to a bank or merchant concerning interest in applying for a new transaction vehicle.

26. The system according to claim 14, further comprising a web-based software application that determines the personalized transaction yield for online recurring payments, although a payment transaction may not be executing when the personalized transaction yield is determined.

27. The system according to claim 16, wherein the processor rewards accumulation goals that alter preferences for a defined period of time, after which point preferences revert to normal.

28. The system according to claim 14, wherein the at least one transaction vehicle comprises a smart card.

29. A computer implemented method of personalizing transaction vehicle rewards and the subsequent processing of payments, comprising the steps of:
receiving a plurality of data inputs, at least some of the inputs being user-generated, at least some of the inputs being bank generated, and at least some of the inputs being merchant generated, each of which being generated dynamically in real-time or stored in a computer memory;
utilizing the data inputs to determine a personalized transaction yield to one or more transaction vehicles, including vehicles that the user currently possesses and those they could possess;
automatically processing the payment, and
transmitting the payment to a consumer device and the merchant's Point of Sale.

30. The method according to claim 29, wherein the transaction vehicle is a debit, credit, prepaid card account, ACH, alternative currency, virtual currency, or person to person transfer.

31. The method according to claim 29, wherein the consumer device is a mobile phone, personal computer, tablet computer, or other computing device accessible to the user in real-time.

32. The method according to claim 29, wherein the personalized transaction yield is determined in real-time or in arrears.

33. The method according to claim 29, wherein a physical location for the transaction vehicle is determined by the computer based on Global Position System (GPS) technology.

34. The method according to claim 29, wherein a physical location for a transaction vehicle is determined based on information received by the computer regarding the physical interaction between consumer device and a merchant's Point of Sale.

35. A computer system for personalizing transaction vehicle rewards comprising:
a rewards personalization engine for processing data in real time to provide recommendation uses a transaction vehicle personalization memory further, comprising:
consumer transaction vehicle account information;
consumer transaction vehicle application information;
consumer preferences information;
transaction vehicle and rewards program information;
merchant industry identifying information;
rewards points values; and
a transmitter for providing a list of personalized transaction yields for at least one transaction vehicle based upon results determined by the reward personalization engine from information in the transaction vehicle personalization memory.

36. The computer system of claim 35, further comprising a rewards bid manager for creating, editing and tracking rewards bids communicated by the transmitter for transaction vehicles competing for a transaction.

37. The computer system of claim 36, wherein the rewards bid manager further comprises a reward bid recommendation engine that provides recommendations for new rewards bids or changes to bids that are currently deemed active by the rewards bid manager.

38. The computer system of claim 36, wherein the rewards bid manager further comprises a mobile network operator, a plurality of client devices and at least one router which collectively provide the reward bids manager with the ability to collect, store and interpret data.

39. The computer system of claim 36 further comprising a personalized purchase likelihood module which processes outputs from the rewards bid manager to help predict whether an input bid will succeed.

40. The computer system of claim 39, wherein the personalize purchase likelihood module further comprises:
a transaction details engine
a user non-preferences engine
a user preferences engine; and
a conversion constraints engine.

41. The computer system of claim 40 wherein the transaction details engine receives data comprising a transaction amount, purchase item categories, merchant information and a rewards bid amount.

42. The computer system of claim 41 wherein personalized purchase likelihood module enables potential customers to be better targeted by the system without data about the specific customer.
